(19) United States
(12) Patent Application Publication
(10) Pub. No.: US 2013/0024177 A1
(43) Pub. Date: Jan. 24, 2013

(54) HYPER-SPATIAL METHODS FOR MODELING BIOLOGICAL EVENTS

(71) Applicant: Garry Nolan, San Francisco, CA (US)

(72) Inventor: Garry Nolan, San Francisco, CA (US)

(73) Assignee: Nodality, Inc., South San Francisco, CA (US)

(21) Appl. No.: 13/636,627

(22) PCT Filed: Mar. 24, 2011
(86) PCT No.: PCT/US11/29845

§ 371 Date: Oct. 8, 2012

Related U.S. Application Data
(60) Provisional application No. 61/317,187, filed on Mar. 24, 2010.

(51) Int. Cl. G06G 7/60

(52) U.S. Cl. 703/11

(57) ABSTRACT

The present invention provides various methods of generating and using models of biological events. The models can be used to classify individuals according to the biological event.

### CROSS-REFERENCE

This application claims the benefit of U.S. Provisional Application No. 61/317,187, filed Mar. 24, 2010, which application is incorporated herein by reference.

### BACKGROUND OF THE INVENTION

Methods for modeling multi-parametric flow cytometry data are helpful in reconstructing biological state transitions based on contemporaneous activation states of different activatable elements. Such methods generate models of state transitions for single activatable elements based on a representative biomarker for which prior data about a sequence of state transitions over time is known. These models of cell states are “stacked” on top of each other to form a model of all of the activatable elements over the temporal progression of a biological event. Such techniques are described in detail in U.S. Publication No. 2009/0063095.

Although these techniques are useful, they are limited to identifying the state transitions of single activatable elements based on a single representative marker. Accordingly, data describing the activation states of activatable elements other than the single representative marker are not considered in generating the state transition model for each activatable element. These data may provide additional resolution of the different state transitions within the biological event and relative to each other. Such resolution of the different state transitions may be used to better characterize the biological event and the dependencies between the activatable elements. Based on this characterization, other cells and cell populations may be classified to determine whether they are within biological states corresponding to biological events.

### SUMMARY OF THE INVENTION

The present invention provides various methods of generating temporal models of biological events. The temporal models are used to generate classifiers that can be applied to activation state data derived from samples to classify the samples according to the biological event. In one embodiment, the present invention provides a method of classifying an individual according to a biological event. The method comprises generating activation state data associated with an individual where the activation state data is based on activation levels of a set of activatable elements in single cells collected from the individual and is generated responsive to modulating the single cells with a modulator. The method further comprises generating an association value that specifies a likelihood that the individual is associated with a biological event based on the activation state data and a temporal model of a biological event. The method further comprises determining whether the individual is associated with the biological event based on the association value.

In some embodiments, the invention provides a computer-implemented method of classifying an individual according to a biological event, the method comprising: (a) receiving, at a computer comprising a memory and a processor, activation state data associated with an individual, where the activation state data comprises activation levels of a set of activatable elements in single cells from the individual; and (b) generating an association value based on the activation state data and a plurality of temporal models, where the plurality of temporal models are associated with a biological event, and where the association value specifies a likelihood that the individual is associated with a biological event. In some embodiments, the biological event is selected from the group of consisting of a drug response, a disease state and cellular differentiation. In some embodiments, the activation state data is generated responsive to modulating the single cells with a modulator.

In some embodiments, generating the association value based on the activation state data and the plurality of temporal models of a biological event comprises: (a) generating a first temporal model based on activation state data associated with one or more individuals who are known not to be associated with the biological event; (b) generating a second temporal model based on activation state data associated with one or more individuals who are known to be associated with the biological event; and (c) generating a classifier based on the first temporal model and the second temporal model. In some embodiments, generating the classifier comprises: (a) generating a first set of descriptive metrics based on the first temporal model; (b) generating a second set of descriptive metrics based on the second temporal model; and (c) generating the classifier based on the first set of descriptive metrics and the second set of descriptive metrics.

In some embodiments, the methods further comprise: (i) generating a third temporal model based on the activation state data associated with the individual; (ii) generating a set of descriptive metrics based on the third temporal model; and (iii) applying the classifier to the set of descriptive metrics that are generated based on the temporal model for the individual.

In some embodiments, the methods further comprise administering a course of treatment to the individual based on the association value. In some embodiments, where the biological event corresponds to at least a first disease state, the methods further comprises diagnosing the individual with the disease state based on the association value.

In some embodiments, the invention provides methods of classifying an individual according to a biological event, the method comprising: (a) generating activation state data associated with an individual where the activation state data comprises activation levels of a set of activatable elements in single cells from the individual; (b) generating an association value that specifies a likelihood that the individual is associated with a biological event based on the activation state data and a temporal model of a biological event; and (c) determining whether the individual is associated with the biological event based on the association value.

In some embodiments, generating an association value that specifies a likelihood that the individual is associated with a biological event based on the activation state data and a temporal model of a biological event comprises: (a) generating a plurality of temporal models based on data associated with a plurality of a samples of single cells collected from a plurality of individuals known to be associated with the biological event; (b) combining the plurality of temporal models to generate a template temporal model, where the template temporal model represents the biological event; and (c) generating an association value based on the activation state data associated with an individual and the template temporal model, where the association value specifies the correlation between the activation state data associated with the individual and the template temporal model.

In some embodiments, the methods further comprise generating a confidence value, where the confidence value specifies the probability of observing the correlation between the activation state data associated with the individual and the template temporal model. In some embodiments, the methods further comprise displaying the activation state data associated with the individual in association with a graphic visualization of the template temporal model, where the activation state data associated with the individual is overlaid on the graphic visualization of the template temporal model.

In some embodiments, the activation state data in the single cells have been determined under culture conditions comprising a modulator. In some embodiments, the activation state data in the single cells have been determined under culture conditions comprising a plurality of modulators. In some embodiments, the modulator is selected from the group of consisting of an activator, an inhibitor and a therapeutic agent. In some embodiments, the modulator is a chemotherapeutic agent, the biological event is response to the chemotherapeutic agent and the set of activatable elements comprise activatable elements associated with the JAK/STAT pathway. In some embodiments, the biological event is acute myeloid leukemia and the set of activatable elements is selected from the group consisting of CD34, CD33, pSTAT5, pSTAT3 and CD11b.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1a illustrates a population of cells undergoing a biological event.

FIG. 1b illustrates a series of state transitions within a biological event.

FIG. 2a illustrates an example of listmode data generated for multi-parametric flow cytometry data according to an embodiment of the present invention.

FIG. 2b illustrates a histogram of activation state data according to an embodiment of the present invention.

FIG. 3a illustrates a table of biological states generated from the gated and/or binned listmode data according to an embodiment of the present invention.

FIG. 3b illustrates a temporal model of biological state transition according to an embodiment of the present invention.

FIG. 4 illustrates a laboratory server 410 according to an embodiment of the present invention.

FIG. 5 illustrates steps performed to generate activation state data according to an embodiment of the present invention.

FIG. 6a illustrates steps performed by the laboratory server 410 to generate a temporal model according to an embodiment of the present invention.

FIG. 6b illustrates detailed steps performed by the laboratory server 410 to generate a temporal model according to an embodiment of the present invention.

FIG. 7a illustrates steps performed by the laboratory server 410 to generate and store classifiers according to an embodiment of the present invention.

FIG. 7b illustrates steps performed by the laboratory server 410 to classify a sample according to an embodiment of the present invention.

FIG. 8a illustrates steps performed by the laboratory server 410 to generate and store a template temporal model for a biological event according to an embodiment of the present invention.

FIG. 8b illustrates steps performed by the laboratory server 410 to associate activation state data from a sample with a template temporal model for a biological event.

FIG. 9 illustrates an example computer for use as a laboratory server 410.

### DETAILED DESCRIPTION OF THE INVENTION

Objects, features and advantages of the methods and compositions described herein will become apparent from the following detailed description. It should be understood, however, that the detailed description and the specific examples, while indicating specific embodiments, are given by way of illustration only, since various changes and modifications within the spirit and scope of the invention will become apparent to those skilled in the art from this detailed description.

All publications, patents, and patent applications mentioned in this specification are herein incorporated by reference to the same extent as if each individual publication or patent application was specifically and individually indicated to be incorporated by reference

The present invention incorporates information disclosed in other applications and texts. The following patent and other publications are hereby incorporated by reference in their entireties: Haskell et al, Cancer Treatment, 5^{th} Ed., W.B. Saunders and Co., 2001; Alberts et al., The Cell, 4^{th} Ed., Garland Science, 2002; Vogelstein and Kinzler, The Genetic Basis of Human Cancer, 2d Ed., McGraw Hill, 2002; Michael, Biochemical Pathways, John Wiley and Sons, 1999; Weinberg, The Biology of Cancer, 2007; Immunobiology, Janeway et al. 7^{th} Ed., Garland, and Leroith and Bondy, Growth Factors and Cytokines in Health and Disease, A Multi Volume Treatise, Volumes 1A and 1B, Growth Factors, 1996. Patents and applications that are also incorporated by reference include U.S. Pat. Nos. 7,381,535, 7,393,656, 7,695,924 and 7,695,926 and U.S. patent application Ser. Nos. 10/193,462; 11/655,785; 11/655,789; 11/655,821; 11/338,957, 12/877,998; 12/784,478; 12/730,170; 12/703,741; 12/687,873; 12/617,438; 12/606,869; 12/713,165; 12/293,081; 12/581,536; 12/776,349; 12/538,643; 12/501,274; 61/079,537; 12/501,295; 12/688, 851; 12/471,158; 12/910,769; 12/460,029; 12/432,239; 12/432,720; and 12/229,476. See especially, U.S. Ser. No. 12/229,476 including the figures. Some commercial reagents, protocols, software and instruments that are useful in some embodiments of the present invention are available at the Becton Dickinson Website http://www.bdbiosciences.com/features/products/, and the Beckman Coulter website, http://www.beckmancoulter.com/Default.asp?bhfv=7. Relevant articles include High-content single-cell drug screening with phosphospecific flow cytometry, Krutzik et al., Nature Chemical Biology, 23 December (2007); Irish et al., FLt3 ligand Y591 duplication and Bcl-2 over expression are detected in acute myeloid leukemia cells with high levels of phosphorylated wild-type p53, Neoplasia, (2007), Irish et al. Mapping normal and cancer cell signaling networks: towards single-cell proteomics, Nature (2006) 6:146-155; and Irish et al., Single cell profiling of potentiated phospho-protein networks in cancer cells, Cell, (2004) 118, 1-20; Schulz, K. R., et al., Single-cell phospho-protein analysis by flow cytometry, Curr Protoc Immunol, (2007) 78:8 8.17.1-20; Krutzik, P. O., et al., Coordinate analysis of murine immune cell surface markers and intracellular phosphoproteins by flow cytometry, J. Immunol. (2005) 175(4):2357-65; Krutzik, P. O., et al., Characterization of the murine immunological signaling network with phosphospecific flow cytometry, J. Immunol. (2005) 175(4):2366-73; Shulz et al., Current Protocols in Immunology (2007) 78:8.17.1-20; Stelzer et al. Use of Multiparameter Flow Cytometry and Immunophenotyping for the Diagnosis and Classfication of Acute Myeloid Leukemia, Immunophenotyping, Wiley, 2000; and Krutzik, P. O. and Nolan, G. P., Intracellular phospho-protein staining techniques for flow cytometry: monitoring single cell signaling events, Cytometry A. (2003) 55(2):61-70; Hanahan D., Weinberg, The Hallmarks of Cancer, CELL (2000) 100:57-70; Krutzik et al, High content single cell drug screening with phophosphospecific flow cytometry, Nat Chem Biol. (2008) 4:132-42; and Monroe, J. G., Ligand independent tonic signaling in B-cell receptor function, Current Opinion in Immunoilogy 2004, 16:288-295. Experimental and process protocols and other helpful information can be found at http:/pr/.eomices.stanford.edu. The articles and other references cited below are also incorporated by reference in their entireties for all purposes.

Many conditions are characterized by disruptions in cellular pathways that lead, for example, to aberrant control of cellular processes, with uncontrolled growth and increased cell survival. These disruptions are often caused by changes in the activity of molecules participating in cellular pathways. For example, alterations in specific signaling pathways have been described for many cancers.

Multiparametric analyses of cells provide an approach for the simultaneous determination of the activation states of a plurality of cellular components. The activation status of the plurality of cellular components can be measured after exposure of cells to extracellular modulators and in so doing allows the signaling capacity of signaling networks to be determined when compared to the activation status of those networks in the absence of such modulators. The induced activation status of a protein rather than the frequently measured basal phosphorylation state of a protein has been shown in several studies to be more informative, as it takes into account (and reveals) signaling deregulation that is the consequence of numerous cytogenetic, epigenetic and molecular changes characteristic of cells associated with a disease state. For example, multiparameter flow cytometry at the single cell level measures the activation status of multiple intracellular signaling proteins as well as assigns activation states of these molecules to the varied cell sub-sets within complex primary cell populations.

Protein phosphorylation and other post translational processes play a role in controlling many cell functions such as migration, apoptosis, proliferation and differentiation. Thus, activation state data can be used to characterize a cell as being within a specific biological state. A biological state is defined, in part, by the activation states of the activatable elements in the cell. Different biological states are associated with a temporal progression of a biological event such as cellular differentiation, migration, apoptosis, proliferation, disease progression or drug response. Biological events can also be induced by stimulation with a modulator. As biological events comprise a series of transitions between biological states over time, different biological states are associated with an order relative to each other in a biological event. Given a large population of cells undergoing some type of biological event, different sub-populations of the cells will be in different biological states that reflect the temporal progression of the biological event. Accordingly, the activation state data for the cells within the population may be used to model the levels of the activatable elements over the temporal progression of the biological event.

In one aspect, the present invention provides methods for the classification of an individual based on a biological event. In another aspect, the present invention provides method for the classification, diagnosis, prognosis, theranosis, and/or prediction of an outcome of a condition in an individual. In one embodiment, the method comprises (a) generating activation state data associated with an individual where the activation state data comprises activation levels of a set of activatable elements in single cells collected from the individual; (b) generating an association value that specifies a likelihood that the individual is associated with a biological event based on the activation state data and a temporal model of a biological event; and (c) determining whether the individual is associated with the biological event based on first said association value.

In some embodiments, the methods described herein provide the relative proportion of different cell sub-populations in different biological states, as well as the speed at which the transitions between biological states occur over time. These temporal models may be used to characterize the individuals from which the different cells populations were derived. Descriptive metrics may be created to characterize both the transitions between biological states over time and the proportion of cells in an individual that are in the different biological states. These descriptive metrics may then be used to generate statistical classifiers that characterize samples of cells as undergoing a specific biological event such as a condition or a reaction to a drug.

In some embodiments, antibodies against state-specific epitopes are used to measure activatable elements characterizing phospho-protein signaling networks, cell cycle progression, apoptotic pathways, protein expression (e.g. transporters, growth factor receptors), other post-translational modifications (e.g. acetylation, methylation, ubiquitination, sumoylation), or conformational changes. Activatable elements can be detected by any suitable reagent or method known in the art besides antibodies and flow cytometry, such as the reagents and methods described in U.S. Pat. Nos. 7,381,535, 7,393,656, 7,695,924 and 7,695,926 and U.S. patent application Ser. Nos. 10/193,462; 11/655,785; 11/655,789; 11/655,821; 11/338,957, 12/877,998; 12/784,478; 12/730,170; 12/703,741; 12/687,873; 12/617,438; 12/606,869; 12/713,165; 12/293,081; 12/581,536; 12/776,349; 12/538,643; 12/501,274; 61/079,537; 12/501,295; 12/688, 851; 12/471,158; 12/910,769; 12/460,029; 12/432,239; 12/432,720; and 12/229,476. Different activatable elements may be detected in response to a combination of modulators that modulate the activatable elements. Such combination of a modulator and an activatable element is called “signaling node”, herein referred to as “node.” The activation levels of the activatable elements are quantified to produce “activation state data” characterizing the response of the activatable element to the modulator.

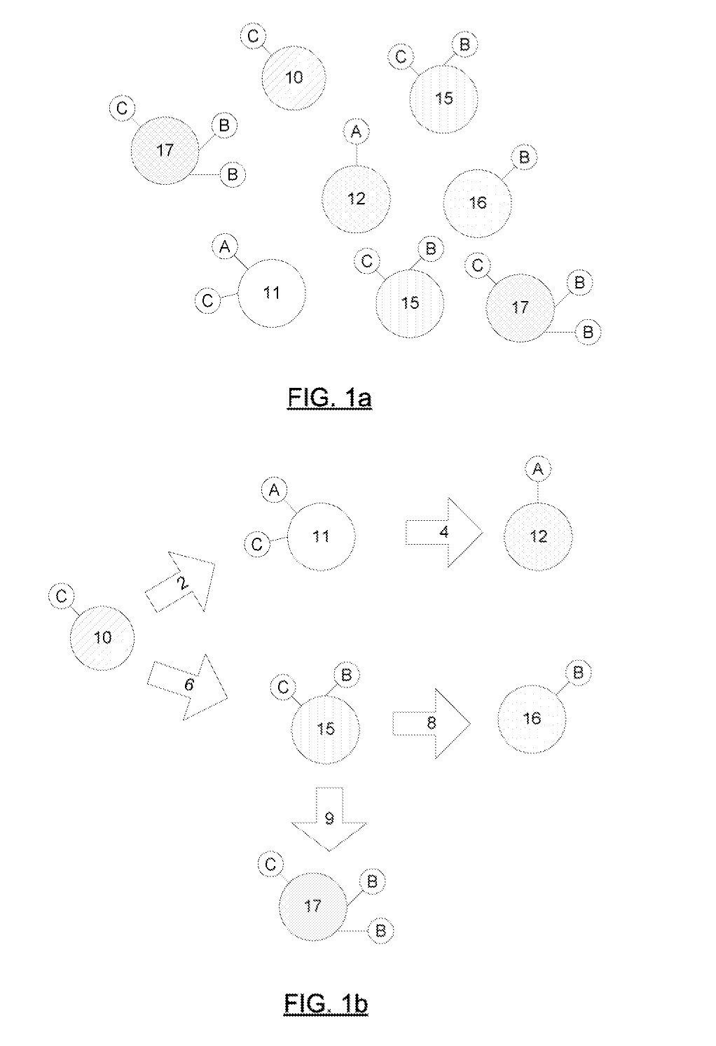

FIG. 1a illustrates a population of cells 10, 11, 12, 14, 15, 16, 17 undergoing a biological event such as disease progression, cell differentiation or drug response. Each of the cells comprises a set of activatable elements. In the example illustrated, the set of activatable elements are cell surface proteins of the cells labeled “A”, “B” and “C.” However, different activatable elements may be used in the present invention. For example, the activatable elements may comprise: proteins that are not surface markers, protein phosphorylation sites, or sites of individual proteins associated with post-translational modifications. Different types of activatable elements for use in the present invention are discussed below in the section titled “Activatable Elements.”

Activatable elements are associated with different activation levels according to their stage of progression in the event. In some embodiments, these activation levels correspond to a quantity of an antibody that measures a relative or absolute quantity of an activation state associated with the activatable element. In the example illustrated, the activation levels correspond to the quantity of the receptors on the surface of the cells. In other instances the activation states may correspond to a quantity of phosphorylated activatable elements or a quantity of activatable elements that have been modified post-translation, for example, by glycosylation. Activation levels and methods of measuring activation levels in cell populations are discussed in the section titled “Generating Activation State Data.”

In some embodiments, the activatable element will be selected based on a pathway or biological process associated with a biological event and the activation level of the activatable element will be quantified in order to model the biological event. In one instance, activatable elements associated with PI3 kinase inhibition may be selected as outlined in U.S. patent application Ser. No. 12/703,741, the entirety of which is incorporated herein by reference, for all purposes. In another instance, activatable elements associated with JAK2 inhibition may be selected and quantified as outlined in U.S. patent application Ser. No. 12/687,873, the entirety of which is incorporated herein by reference, for all purposes. In another instance, activatable elements associated with cell cycle regulation may be selected and quantified as outlined in U.S. patent application Ser. No. 12/713,165, the entirety of which is incorporated herein by reference, for all purposes. In these instances, the activation levels associated with the activatable elements can be modeled over biological events such as cancer in which the alteration of pathways known to affect PI3 kinase, cell cycle regulation and JAK2 is associated with carcinogenesis. Data used to model carcinogenesis may be derived from cells known to be associated with a specific type, stage or sub-type of cancer.

In some embodiments, the activatable elements may be selected based on their association with the biological event. For example, in one instance, the activatable elements may be selected based on their association with Chronic Lymphoid Leukemia as outlined in U.S. Provisional Patent Application No. 61/308,872, the entirety of which is incorporated herein by reference, for all purposes. In another instance, the activatable elements may be selected based on their association with Acute Myeloid Leukemia as outlined in U.S. Provisional Patent Application No. 61/104,666, the entirety of which is incorporated herein by reference, for all purposes. Other activatable elements associated with biological events such as disease states, prognoses, and response to therapy will be known to those skilled in the art.

In some embodiments, the cells that are being analyzed will be treated with a modulator that can either induce or repress an activation state of the activatable element. Modulators are discussed below in the section entitled “Modulators.” Additionally, the cells may be treated with various concentrations of modulators and the activation response may be characterized using a curve that represents response to a drug, similar to an IC50 (half maximal inhibitory concentration) or an EC50 (half maximal effective concentration) curve. In some embodiments, the activation state data for the activatable elements may be measured at different time points following exposure to a modulator.

FIG. 1b illustrates a series of state transitions within a biological event. Arrows 2, 4, 6, 8, 9 are used to represent state transitions between different biological states in the biological event. A biological state, as used herein, refers to the activation state profile of the cell, that is the unique combination of activation states of the activation elements in the cell. Although the different biological states 10, 11, 12, 15, 16, 17 in the biological event are depicted as single cells, populations or sub-populations of large numbers of cells (e.g. hundreds, thousands or millions of cells) might be in a same biological state. In progenitor state 10 a cell expresses cell surface protein “C”. Progenitor state 10 transitions 2 into state 11 through the additional expression of cell surface protein “A”. State 11 transitions 4 to state 12 through the loss of expression of cell surface protein “C.” Progenitor state 10 transitions 6 into state 15 through the additional expression of cell surface protein “B.” State 15 transitions 8 into state 16 through the loss of expression of cell surface protein “B.”

Activation levels of the activatable elements vary according to the different biological states that cells are in. For example, in states 10, 15, 16, and 17 receptor “A” has an activation level of zero or “off”. In state 11, cell surface proteins “A” and “C” have activation levels that can either represent that the activatable element is active or “on” or represent a relative quantity of activation. In this example activation is quantified in terms of expression. However, in other embodiments activation may represent, for example, signaling and/or protein modification. Sometimes, cells in a biological state may transition to a different biological state based on an increased quantity of activation (i.e. an increase in the activation state of an activatable element). In the example illustrated in FIG. 1b, state 15 transitions 9 to state 17 through increased expression of signal receptor “B”. The increased expression may be a large increase such as a fold increase of the activation state data associated with the previous cell state, these increases are herein referred to as “step up increases.” The increased expression 9 may be a numerical increase that corresponds to a large number of biological states over which the expression of “B” incrementally increases. These series of biological states are herein referred to as “continuous increases.”

The transitions 2, 4, 6, 8, 9 between biological states can be associated with different probabilities of occurrence. In the example illustrated, transitions 2 and 6 represent a “bifurcation” in which a cell can transition 2 into one cell lineage 11 or transition 6 into another cell lineage 15. Different transitions in a bifurcation can have different probabilities of occurring. In the non-limiting example illustrated, the progenitor cell 10 may have a 70% probability of transitioning 2 into cell lineage 11 and a 30% probability of transitioning 6 into cell lineage 15. Any of the above transitions 2, 4, 6, 8, 9 can represent a transition that is found within cells that are associated with a biological event such as a known disease or dysfunction or a transition that occurs because of aberrant cell regulation of expression or a signaling pathway. Different diseases or dysfunctions can include a diagnosed condition (e.g. Acute Myeloid Leukemia (AML), Chronic Lymphoid Leukemia (CLL)) or any phenotype corresponding to some state, stage or classification of a known disease state (e.g. M3 Subtype of AML). Other conditions that can be modeled using the techniques described herein are discussed below in the section entitled “Conditions.” The transitions can also represent prognoses, pre-disease states or states that precede a formal diagnosis of disease. For example, the transitions 2, 4, 6, 8, 9 could represent transitions that occur as part of cell differentiation or as an aberrant cell cycle regulation progressively worsens, leading to a cancer or pre-cancer state. Additionally, any of the above transitions may have an equal probability of occurring or may have different probabilities of occurring, depending on disease states. For instance, if transition 9 to state 17 represents over-expression correlated with a disease state, transition 9 may have a low probability of occurring in a healthy population of cells.

Similarly, different transitions or probabilities of transitions may be associated with the biological event of drug response in diseased cells. Drug-sensitive cells may be more likely than drug-resistant cells to undergo a transition after drug treatment or vice-versa. Accordingly, the likelihood of a cell undergoing a transition from one biological state to another biological state over time can be predictive of how a patient will respond to a specific drug therapy. Consequently, a transition from one biological state to another may be used to characterize a lack of response to drug therapy.

Because of this association between transitions and prognosis, diagnosis and/or drug responses, it is valuable to model the different temporal transitions between biological states in cell populations. Given that different cells in a population can be in a number of different biological states, it is imperative to have a mechanism to order the biological states into a temporal model of a biological event.

Once such a model is made, different temporal models derived from different samples of cell populations may be used to compare the series of transitions that happen in different biological events such as disease and/or drug response. This information provides an ordered perspective as to the relative proportion of the different cell sub-populations that are in different biological states, as well as the speed at which the transitions between biological states occur over time. In this way, temporal model may be used to characterize the sample of cells from which the temporal model was derived. Descriptive metrics may be created to characterize both the transitions between biological states over time and the proportion of cells in a sample that are in the different biological states. These descriptive metrics may then be used to generate statistical classifiers that characterize samples of cells as undergoing a specific biological event such as a condition or a reaction to a drug.

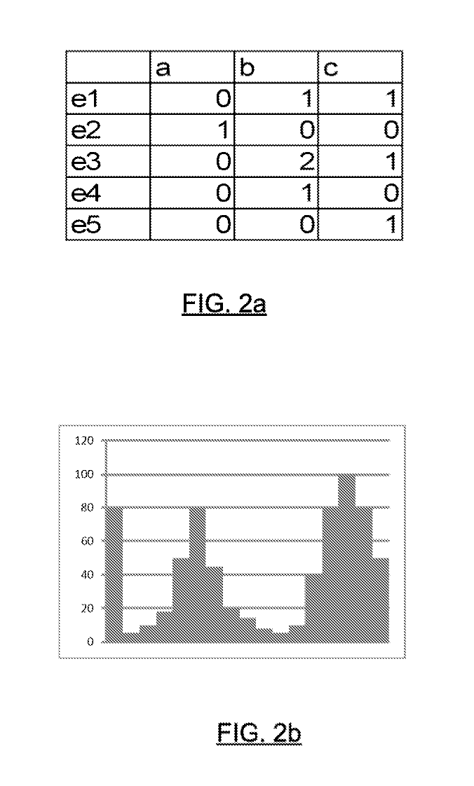

FIG. 2a illustrates an example of listmode data. The listmode data comprises a set of parameters “A”, “B” and “C” that are quantified for single cells “e1”, “e2”, “e3”, “e4” and “e5” in a cell population. The set of parameters correspond to activation state data that represents a quantity of an activatable element in an activation state a single cell. In some embodiments, activation state data is generated using multi-parametric flow cytometry or equivalent technologies.

According to one embodiment, the listmode data may be transformed in a number of ways prior to model generation. In one embodiment, the listmode data may be gated to select a subset of cells for further analysis or to identify cells associated with a same activation state. Gating is a method by which sub-populations of cells are selected based on the activation state data for a given activatable element. Depending on the activatable element quantified, the activation states may indicate that cells have different cell types or are associated with different biological states in a biological event. Gating can be performed, in some part, manually or can be performed automatically. Suitable methods for gating are outlined in U.S. patent application Ser. No. 12/501,295, the entirety of which is incorporated by reference herein for all purposes. FIG. 13 of U.S. patent application Ser. No. 12/501,295, provides an illustration of gated data.

Similar to gating, the activation state data may be segregated into bins at different resolutions in order to identify a discrete number of activation states associated with the cells. Methods for segregating the activation state data into multi-resolution bins are described in U.S. Publication No. 2009/0307248, the entirety of which is incorporated herein for all purposes. Using these methods, the probability density of activation state data associated with an activatable element may be iteratively segregated into finer-resolution bins. These multi-resolution bins may then be used to identify activation states, cell states and/or different cell types associated with the different multi-resolution bins.

In some embodiments, the activation state data associated with the cells may be discretized or “binned” into different categorical activation states. Binning or discretization may be based on gating and/or multi-dimensional representation. In embodiments where binning is based on gating and/or multi-dimensional representation, activation state data associated with a selected or binned subset of cells can be combined to create an average value used to represent the categorical activation states. In combining the data, a probability density can be generated for the categorical activation level.

In some instances, the activation state data may be discretized into binary categorical activation states corresponding to “on” or “off” states of the activatable element. In other instances the activation state data may be binned into discrete categorical activation states corresponding to ordered levels of activation. In some embodiments, Gaussians or histograms are used to, either manually or automatically, discretize the activation state data into continuous categorical activation states. FIG. 2b illustrates a histogram of activation state data associated with a population of cells, the histogram having a peak at a categorical activation level of zero and two higher peaks. Using the histogram illustrated in FIG. 2b, discrete categorical activation states corresponding to the peaks in the data may be identified.

In some embodiments, some or all of the activation state data is represented as continuous activation states corresponding, at least in part, to the raw or normalized activation state data (i.e. the activation levels of the activatable elements). In specific embodiments, the continuous activation states correspond to a logarithm or other numeric transform of the activation state data associated with an activatable element. Continuous activation states are also generated by applying regression algorithms or smoothing algorithms prior to processing the activation state data.

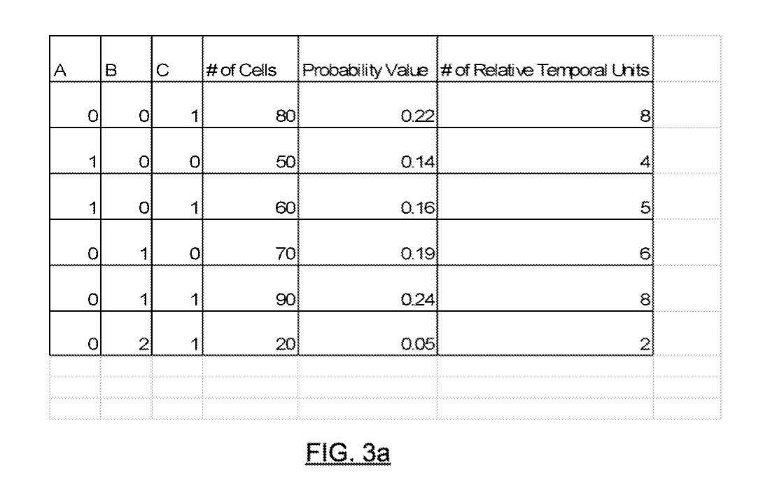

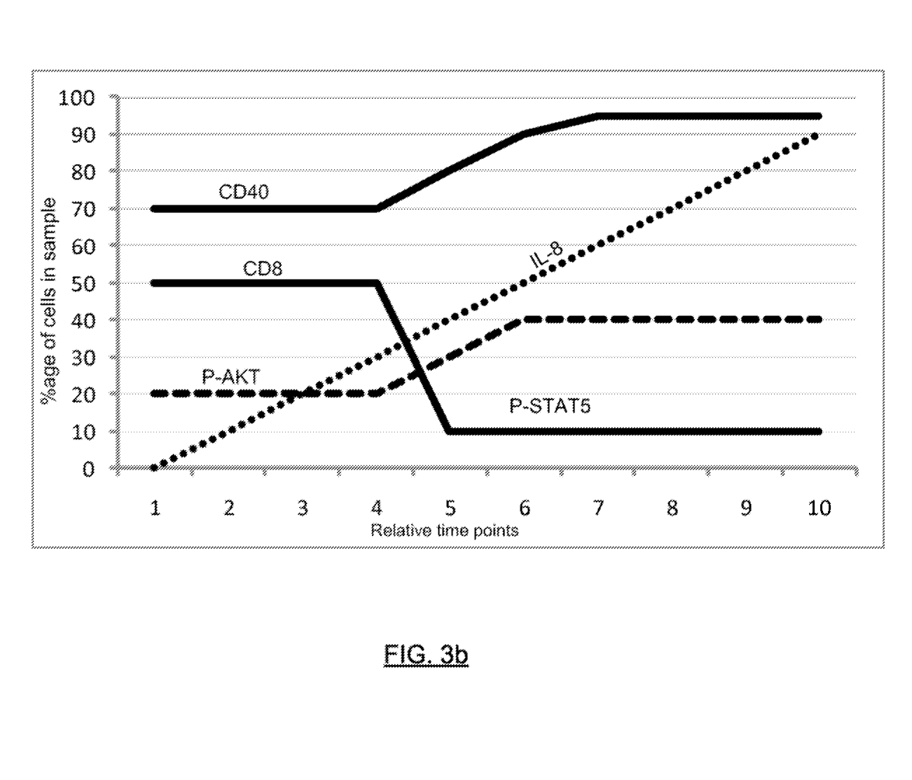

FIG. 3a illustrates a table of biological states generated from the gated and/or binned listmode data. The table is generated by identifying different biological states based on the different combinations of continuous and/or categorical activation states associated with the single cells. Once the biological states are identified, the number of cells in each biological state is determined by enumerating the number of cells that has the combination of continuous and/or categorical activation states used to characterize the biological state. A probability value is then generated by dividing the number of cells the in the biological state by the number of cells associated with the activation state data selected for model generation. The probability value represents the likelihood that a cell in the cell population derived from a sample of cells would be in the biological state.

The probability values are used to determine an initial number of relative temporal units to assign to each biological state in constructing the biological state model. A relative temporal unit is a value used to associate the identified biological states with points along a temporal axis. The probability values correlate to the number of relative temporal values, because the probability of observing a biological state is roughly proportional to the amount of time that cells are within the biological state.

Although the number of relative temporal units corresponds to the probability values associated with the biological states, relative temporal units are essentially arbitrary values that are iteratively refined as the model is constructed. For example, a certain biological state may be represented using a larger number of relative temporal units based on a priori data. Alternatively, if a bifurcation between biological states is identified based on other data, the relative temporal units for the two different biological states may be adjusted based on these data. Relative temporal units may be refined based on automatically or manually determined data. If the biological state transitions are expected to occur with equal frequency, then the relative temporal units associated with each state may be equal.

FIG. 3b illustrates a temporal model of biological state transitions. This temporal model is generated by iteratively ordering the biological states along the temporal axis. The x-axis of the graph comprises the relative temporal units. The number of cells within a set of categorical and/or continuous activation states associated with different biological states is plotted along the y-axis. The number of cells may be represented as an absolute number, or as a percentage of the number of cells used to generate the temporal model.

Graphic visualizations such as line plots provide a method of visualizing the biological states characterized by the activation state data and the transitions between the biological states. The order of relative time points in association with a specific activatable element is herein referred to as the “profile” for the activatable element. The relative temporal units are ordered along the x-axis to approximate the series of state transitions that occur during the biological event. The order of the relative temporal units is determined using the methods described below. Different methods for determining the order may be applied alone or in combination in a number of different orders.

In some embodiments of the method described herein, the temporal model is generated by iteratively evaluating the different activatable elements relative to each other to determine an optimal order of the relative time points. Prior to iteratively modeling the data, the program may partially determine information used to generate the temporal model such as bifurcations in the biological state transitions. Bifurcation information is used to partition populations of cells prior to generating the temporal model. Using the example illustrated in FIG. 1b, the program can determine that activatable elements “A” and “B” are never activated together and therefore may be exclusively activated in different sub-populations of cells.

Methods of determining state transitions and bifurcations include the use of Bayesian statistics and mutual information values to determine which activatable elements are predictive of other activatable elements. For instance, the activation state data for activatable elements A and B will have a high mutual information value if the absence of A in a cell is almost always predictive of a presence of B in a cell. This high mutual information value can be used to infer a bifurcation. Bifurcations in biological states can also be manually modeled based on known prior data or by generating graphic displays of the data such as two-dimensional plots similar to the one shown in FIG. 2b. Bifurcations may also be identified using Bayesian networks generated based on a priori data or inferred from activation state data compiled for a large number of biological states and biological events.

After the bifurcations have been identified, the temporal model is generated by iteratively re-ordering the relative time points associated with the biological states. The time points are iteratively re-ordered using a combination of the following methods:

A priori information: In embodiments where a priori information is used to order the relative temporal units along the temporal axis (x-axis), one or more representative activatable element(s) are selected by a user and an order of the categorical/continuous activation states associated with the activatable elements are specified. Typically, the representative activatable element is a single activatable element that has a characteristic increase or decrease in its activation state data over the biological event. In some instances, the representative marker can comprise two or more activatable elements that have characteristic increases or decreases over the biological event. The categorical and/or continuous activation states associated with the other activatable elements are then re-ordered over the temporal axis according to the specified order of the representative activatable element(s).

After the categorical activation states for the remaining activatable elements have been initially sorted based on their representative activatable elements, activation profiles for the other activatable elements are iteratively sorted to generate a temporal model. The order of iterative sorting of the subsequent profiles may be specified by a user or determined automatically as described below. Likewise, a computational heuristic may be used to determine whether an optimal temporal model has been generated or the temporal model may be visually inspected by a user to determine a level of “goodness” of the model.

Algorithmic methods: In instances where the order is determined automatically, the profiles are iteratively sorted according to the biological states associated with the categorical and/or continuous activation states. For example, the program may select to first sort biological states according to a complexity of the activation state data associated with the activatable element. As used herein, the complexity of an activatable element with respect to biological states refers to number of different biological states associated with a “transition” between two categorical activation states of the activatable element. High complexity activatable elements are useful in generating a temporal model because the number of cells in different biological states varies greatly over the relative time points. This variation is used to order the relative time points according to the transition between the two categorical activation states.

The profiles for the remaining activatable elements are then iteratively sorted. In most embodiments, the activatable elements will be sorted according to their complexity with the profiles for higher-complexity activatable elements being sorted prior to lower-complexity activatable elements. In some embodiments, the sorted profiles are evaluated according to a heuristic to determine the “goodness” of the order to the relative temporal units. Different algorithms that employ heuristics to determine an optimal order may be used for this purpose. These algorithms include but are not limited to: genetic algorithms, regression models, finite spanning trees and finite state models. In most embodiments, the heuristic is based on the “shape” of each profile in the graph. Profiles with plateaus or slopes indicating linear transitions between categorical activation states are favored because this accords with accepted knowledge of biological state transitions. In other embodiments, other heuristics may be used. In some embodiments, the number of relative time points associated with the biological states may be adjusted in order to generate sorted profiles that better conform to the heuristic.

In some embodiments, computational methods may be used in combination with other a priori biological information to iteratively sort the profiles. Other a priori biological information can include but is not limited to any combination of: RNA-expression-based information, protein-expression-based state, and clinical information.

In one embodiment, the temporal model may be aggregated with other temporal models of the same biological event to generate a template temporal model representing state transitions within the biological event. For example, in instances where the biological event modeled is disease progression, a set of temporal models generated from samples collected from different patients with the disease may be aggregated. Likewise, samples from different patients that exhibit drug resistance may be aggregated and modeled. When aggregating temporal models, a degree of confidence may be assigned to different relative time points based on the agreement between the relative time points in the different temporal models. Conversely, a desirable feature of single-cell activation state data is the ability to aggregate activation state data from several different samples before constructing a state transition model. In these instances, single-cell activation state data from a variety of samples undergoing the same biological event may be pooled prior to constructing a model.

The template temporal model for the biological event can then be used to determine whether single-cell activation state data corresponds to the biological event. For a newly received sample comprising a population of cells, activation state data can be generated for each cell in the sample. Accordingly, each cell may be compared to the template temporal model and it can be determined whether the cell corresponds to a state found within the model and whether the proportion of the population of cells in each state corresponds to the model.

A number of different types of data may be derived from the temporal model and used in subsequent applications and methods of classification. In one embodiment, the temporal model will be used to generate a Bayesian network or decision tree data structure. In some embodiments, a set of descriptive metrics will be generated based on the temporal model and used to classify the data. These descriptive metrics can include values that describe the shape of the profiles over the relative temporal axis or the shape of the profiles relative to each other such as quadratic equations, integrals, derivates or rates of change. The descriptive metrics for a temporal model may then be used as features in machine learning applications that seek to generate a classifier that can be used to discriminate temporal models associated with a biological event from other temporal models associated with other biological events.

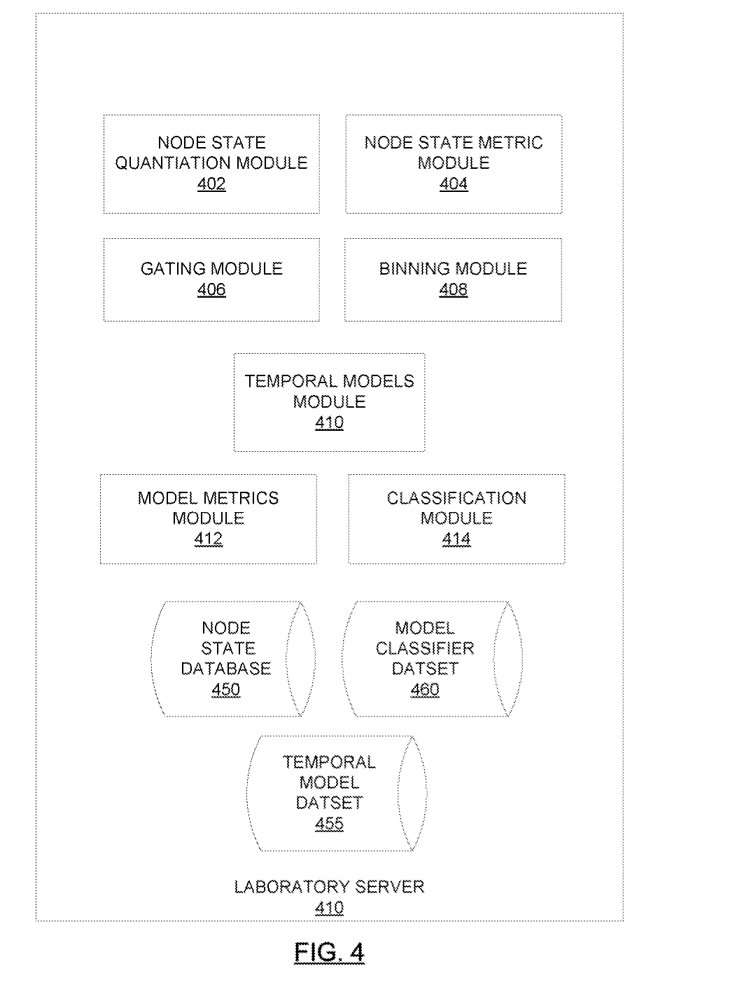

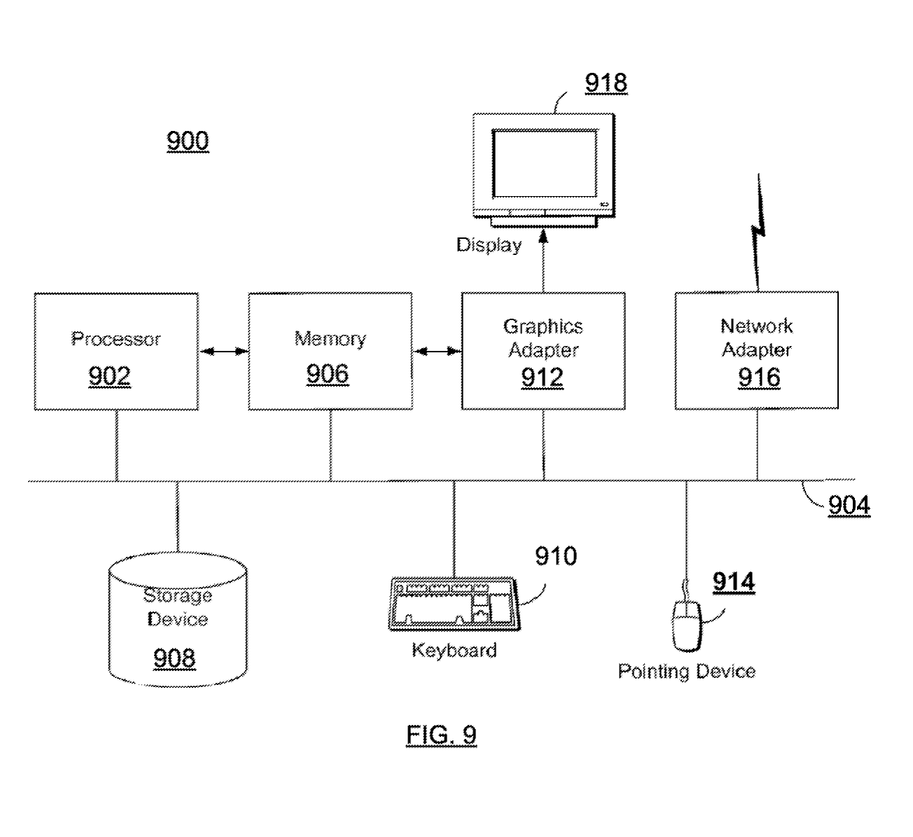

FIG. 4 illustrates an exemplary embodiment of the invention. FIG. 4 illustrates a system 400 comprising a laboratory server 410 according to one embodiment of the present invention. The laboratory server 410 is a computer 900. FIG. 9 illustrates an example computer 900. The laboratory server 410 comprises a activation state quantitation module 402, a activation state metric module 404, a gating module 406, a binning module 408, a temporal models module 410, a model metrics module 412, a classification module 414, a activation state database 450 and a model classifiers dataset 460. The functions performed by the laboratory server 410 are separated into modules for the purposes of discussion only. Different embodiments of the present inventions may distribute functions among modules in different ways. Likewise, different embodiments of the present invention may store the different types of data in different arrangements than discussed herein or in databases that are external to the laboratory server 410.

The activation state quantitation module 402 functions to generate raw activation state data by communicating with one or more programs or machines used to generate quantitative biological data. In some embodiments, the activation state quantitation module 402 will communicate with a flow cytometer to receive raw activation state data. In some embodiments, the activation state quantitation module 402 will further comprise experiment management software that may be used by the third party to design aspects of flow cytometry experiments such as well/plate design. Such software for experiment management is fully described in U.S. Ser. No. 12/501,274, the entirety of which is incorporated herein.

The activation state quantitation module 402 processes and normalizes the raw signal data generated from the quantitation of the activation state data associated with an activatable element. Methods for processing signal data are described in US publication number 2006/0073474 entitled “Methods and compositions for detecting the activation state of multiple proteins in single cells” and below in the sections entitled “Generating Activation Sate Data” and “Modeling Activation State Data”.

The activation state metric module 404 functions to generate metrics representing different activation states based on the raw activation state data. The activation state metric module 404 generates a “basal” metric characterizing the response of an activatable element by determining the log₂ fold difference in the Median Fluorescence Intensity (MFI) of a sample treated with a modulator divided by a sample that is not treated with a modulator. The activation state metric module 404 generates a “total phospho” metric. The total phospho metric is calculated by measuring the autofluorescence of a cell that has been stimulated with a modulator and stained with a labeled antibody. The activation state metric module further 404 generates a “fold change” metric. The fold change metric is the measurement of the total phospho metric divided by the basal metric. The activation state metric module 404 generates a quadrant frequency metric, which represents the frequency of cells in each quadrant of the contour plot.

According to the embodiment, the activation state metric module 404 may generate any of the following metrics: 1) a metric that measures the difference in the log of the median fluorescence value between an unstimulated fluorochrome-antibody stained sample and a sample that has not been treated with a stimulant or stained (log(MFI_{Unstimulated Stained})−log(MFI_{Gated Unstained})), 2) a metric that measures the difference in the log of the median fluorescence value between a stimulated fluorochrome-antibody stained sample and a sample that has not been treated with a stimulant or stained (log(MFI_{Stimulated Stained})−log(MFI_{Gated Unstained})), 3) a metric that measures the change between the stimulated fluorochrome-antibody stained sample and the unstimulated fluorochrome-antibody stained sample log(MFI_{Stimulated Stained})−log(MFI_{Unstimulated Stained}), also called “fold change in median fluorescence intensity”, 4) a metric that measures the percentage of cells in a Quadrant Gate of a contour plot which measures multiple populations in one or more dimension 5) a metric that measures MFI of phosphor positive population to obtain percentage positivity above the background and 6) use of multimodality and spread metrics for large sample population and for subpopulation analysis. In some embodiments, the activation state metric module 404 will generate an “equivalent number of reference fluorophores” value (ERF) which is a transformed value of the median fluorescent intensity values. The ERF value is computed using a calibration line determined by fitting observations of a standardized set of S-peak rainbow beads for all fluorescent channels to standardized values assigned by the manufacturer. The ERF values for different samples can be combined in any way to generate different activation state metric. Different metrics can include: 1) a fold value based on ERF values for samples that have been treated with a modulator (ERFₘ) and samples that have not been treated with a modulator (ERFᵤ), log₂ (ERFₘ/ERFᵤ); 2) a total phospho value based on ERF values for samples that have been treated with a modulator (ERFₘ) and samples from autofluorecsent wells (ERFₐ), log₂ (ERFₘ/ERFₐ); 3) a basal value based on ERF values for samples that have not been treated with a modulator (ERFᵤ) and samples from autofluorescent wells (ERFₐ), log₂ (ERFᵤ/ERFₐ); 4) A Mann-Whitney statistic Uᵤ comparing the ERF_{m and} ERFᵤ values that has been scaled down to a unit interval (0,1) allowing inter-sample comparisons; 5) A Mann-Whitney statistic Uᵤ comparing the ERF_{m and} ERFᵤ values that has been scaled down to a unit interval (0,1) allowing inter-sample comparisons; 6) a Mann-Whitney statistic Uₐ comparing the ERFₐ and ERFₘ values that has been scaled down to a unit interval (0,1); and 7) A Mann-Whitney statistic U75. U75 is a linear rank statistic designed to identify a shift in the upper quartile of the distribution of ERFₘ and ERFᵤ values. ERF values at or below the 75^{th} percentile of the ERFₘ and ERFᵤ values are assigned a score of 0. The remaining ERFₘ and ERFᵤ values are assigned values between 0 and 1 as in the Uᵤ statistic. For activatable elements that are surface markers on cells, the activation state metric module 404 may further generate: 1) a relative protein expression metric log 2(ERFₛₜₐᵢₙ)−log 2(ERF_{control}) based on the ERF value for a stained sample (ERFₛₜₐᵢₙ) and the ERF value for a control sample (ERF_{control}); and 2) A Mann-Whitney statistic Ui based the comparing the ERFₘ and ERFᵢ values that has been scaled down to a unit interval (0,1), where the ERFᵢ values are derived from an isotype control

The activation state metric module 404 may also function to generate graphic visualizations of the activation state data such as scatter-plots, histograms, box-and-whisker plots, third-color analysis plots (3D plots); percentage positive and relative expression of various markers.

Both the activation state quantitation module 402 and the activation state metric module 404 are adapted to save the activation state data in the activation state database 450. The activation state data for each cell is saved in association with an identifier for the cell and the sample associated with the cell. In some embodiments, the activation state data is saved as listmode data in association with data that uniquely identifies the sample the data was derived from such as a tracking number. The activation state data is also saved in the activation state database 450 in association with information that uniquely identifies a biological event associated with the activation state data such as a disease, a type of cell differentiation or a response to a modulator. Other information stored in associated with the activation state data can include, but is not limited to: a phenotype of the cells associated with the sample, a genotype of the cells associated with the sample and clinical data/metrics associated with the sample.

The gating module 406 functions to identify sub-populations of cells and/or categorical activation states based on activation state data associated with single cells. The gating module 406 identifies distinct subpopulations of cells based on a multidimensional representation of the activation state data associated with one or more activatable elements. In one embodiment, the gating module 406 identifies the sub-populations of cells with distinct activation states and displays the activation state data as a two-dimensional scatter-plot wherein the sub-populations are “gated” or demarcated within the scatter-plot. According to the embodiment, the homogeneous subpopulations may be gated automatically, manually or using some combination of automatic and manual gating methods. In some embodiments, a user can create or manually adjust the demarcations to generate new sub-populations of cells. Suitable methods of gating sub-populations of cells are described in U.S. patent application Ser. No. 12/501,295, the entirety of which is incorporated by reference herein, for all purposes.

The binning module 408 functions to identify categorical activation states based on activation state data. In some embodiments, the binning module 408 communicates with the gating module 406 to identify discrete sub-populations of cells. Based on the discrete sub-populations of cells, the binning module 408 identifies categorical activation states corresponding to a representative activation state value of the sub-populations of cells. The representative activation state value can be a median activation level, a mean activation level or any other appropriate function of the activation levels associated with the identified sub-population of cells. The binning module 408 can further identify additional data that represents a probability density or confidence value associated with the identified categorical activation state.

In some embodiments, the binning module 408 generates a set of multi-resolution bins according to the method outlined in U.S. Publication No. 2009/0307248. The binning model 408 then identifies categorical activation states for each multi-resolution bin as outlined above with respect to FIG. 2a.

The temporal models module 410 functions to generate temporal models of biological state transitions. The temporal models module 410 pre-processes activation state data by identifying dependencies between activatable elements, then iteratively re-orders the profiles for the activatable elements to generate a temporal model of a biological event.

The temporal models module 410 identifies bifurcations in the state transitions prior to generating the temporal model. The temporal models module 410 identifies bifurcations based on mutual information values derived from the activation state data associated with cells undergoing a biological event. The temporal models module 410 also identifies bifurcations based on other models of state transitions such as Bayesian models.

Bayesian models used to supplement the temporal models may be generated using inference methods, methods that make use of known causal interactions between activatable element or combinations thereof. Suitable methods for generating Bayesian models of activation state data using inference-based methods are outlined in U.S. patent application Ser. No. 11/338,957 the entirety of which is incorporated by reference herein for all purposes. Known causal interactions between activatable elements may be specified by a user or obtained automatically using information from publicly available ontology and pathway databases and/or information mined from the biological literature using computational linguistics techniques. Unlike the temporal models of a single biological event, Bayesian models may be generated based on activation state data from a large number of biological events such as diseases or responses to modulators. It is desirable to model a large number of biological events in a Bayesian network because different biological events comprise a diversity of state transitions that cannot be obtained otherwise. The greater the number of state transitions, the greater the accuracy of the causal relationships in the Bayesian network inferred by the model. However, Bayesian Networks lack a temporal aspect that is critical in modeling differences between biological events. Therefore, the present method of generating temporal models and methods of generating Bayesian may be used in conjunction to iteratively refine and validate the models produced by the two methods. The temporal models module 410 can also identify bifurcations based on a priori knowledge of cellular interactions received directly from a use of the laboratory server 410.

In some embodiments, the temporal model module 410 then generates the temporal model using a combination of iterative methods. In some embodiments, the temporal model module 410 receives a selection of one or more representative marker(s) from the user and a specification of an order of the categorical/continuous activation states associated with the representative markers(s). The temporal model module 410 first generates an initial order of the relative time points associated with the activatable elements based on the order of the representative marker(s). The temporal model module 410 iteratively refines the initial order of the relative time points based by sorting data for each of the remaining activatable elements relative to the order of the representative marker and each other.

In other embodiments, the temporal model module 410 generates an initial order of the relative time points based on a high complexity activatable element. The temporal model module 410 then iteratively refines the initial order of the relative time points based by sorting data for each of the remaining activatable elements relative to the order of the high complexity activatable element and the other activatable elements. In some embodiments, the temporal model module 410 uses a combination of representative marker and complexity-based methods in order to iteratively refine the relative time points associated with each activatable element.

The temporal model module 410 can further function to aggregate temporal models generated from different populations of cells undergoing a same biological event to generate a template temporal model. The temporal model module 410 normalizes the temporal models based on the number of relative time points in each model and the number of cells used to generate the temporal model. The temporal model module 410 then determines, for each activatable element, a representative (e.g. mean or median) number of cells that are associated with an activation level of the activatable element at each ordered relative time point. The temporal model module 410 stores the representative cells as a template temporal model. The temporal model module 410 further determines a confidence interval associated with the representative number of cells at each time point.

The temporal model module 410 functions to display graphic visualizations of the temporal models and template temporal models. In one embodiment, the temporal model module 410 displays the temporal models as line graphs over relative temporal values as shown in FIG. 3b. The temporal model module 410 further displays the confidence values such as confidence intervals or probability densities associated with the template temporal models on the line graph.

In displaying temporal models as line graphs or other graphic visualizations, the temporal model module 410 can overlay activation state data derived from a sample onto a temporal model or a template temporal model associated with a biological event. This allows an observer to qualitatively determine whether the activation state data for the cells in the sample corresponds to the model/biological event. In some embodiments, a graphic visualization of a temporal model for the sample data will be generated and overlaid on a graphic visualization of the template temporal model. In these embodiments, the temporal model for the sample data may be based, in part, on a priori information obtained from generating the template temporal model.

The temporal model module 410 also generates quantitative association values indicating the statistical correlation between the associated state data from a sample and the template temporal model, such as values indicating an expected and an observed correspondence between the association state data from the sample and the template temporal model. The template temporal model 410 further generates a confidence value that specifies the probability that the sample is associated with a biological event represented by the template temporal model.

The association value and confidence value may be used to diagnose individuals with being associated with biological events such as conditions or a predicted drug response. In one embodiment, the association value and/or the confidence value may be subject to a threshold value in order to determine whether or not the individual is associated with a biological event. As a purely illustrative example, a threshold association value of 80% similarity and a threshold confidence value of 90% could be used. Any threshold association value and confidence value could be used to perform a diagnosis but preferred embodiments would use a threshold association value greater than 60% and a threshold confidence value greater than 70%.

The model metrics module 412 generates descriptive metrics based on the temporal models. The model metrics module 412 generates descriptive metrics that indicate how an activatable element changes activation states over time or metrics that indicate how activatable elements change activation states relative to each other. The model metrics module 412 can generate any type of descriptive metric describing the rate of change of one or more numeric values over time, including but not limited to: quadratic equations, integrals, percent positions, splines, derivates and Boolean representations of the changes of the activatable elements over time.

The classification module 414 generates classifiers based on the descriptive metrics. The classification module 414 identifies sets of temporal models associated with a biological state. For each temporal model in a set of temporal models, the classification module 414 communicates with the model metrics module 412 to generate a feature vector comprising descriptive metrics for the temporal model. The classification module 414 generates a classifier based on descriptive metrics in the feature vectors derived from the temporal models associated with one or more biological events. A classifier is a statistical model that specifies a set of features that can be used to discriminate between two classes, such as two different biological events or two different phenotypes of cells. The classification module 414 may use any type of classification algorithm to generate the classifier, including but not limited to support vector machines (SVM), logistic regression, bagging, boosting and neural networks. The classification module 414 stores the classifier in the model classifier dataset 460.

In some embodiments, the classification module 414 also generates classifiers based on Bayesian networks generated from the temporal models. In these embodiments, the classification module 414 first generates a Bayesian network based on the information associated with a set of temporal models associated with a biological event. The classification module 414 then generates feature vectors corresponding to descriptive metrics that characterize the arcs in the Bayesian networks, where the arcs describe causal relationships between different activatable elements at different relative time points. The classification module 414 stores the classifier in the model classifier dataset 460.

The classification module 414 further applies classifiers to activation state data associated with a sample in order to produce an association value that indicates the statistical association between a sample and a biological event. The classification module 414 communicates with the temporal model module 410 to generate a temporal model based on the activation state data associated with the sample. The classification module 414 then communicates with the model metric module 412 to generate a feature vector based on the temporal model.

The classification module 414 then applies one or more classifiers to the feature vector derived from the sample activation state data to generate one or more association values. In one embodiment, the association value will be represented as a probability value that indicates the likelihood that the sample is associated with a biological event associated with the classifier. In one embodiment, the association value will represent a degree of similarity or association between the sample and biological event. In some embodiments, the classification module 414 stores the association values in a database. In some embodiments, the classification module 414 determines whether the sample is associated with a biological event based on the association value exceeding a threshold value (e.g. 70%, 75%, 80%, 85%, 90%, 95% probability).

In some instances, the association value may be used to guide treatment of an individual from whom the sample is derived. For example, if the sample is derived from an individual suffering from a hematological malignancy and the biological event is a loss of sensitivity to drug treatment, an association value specifying a high likelihood of loss of sensitivity to their current drug treatment could be used by a physician could alter their treatment regimen and administer a new course of treatment based on this association value. In this instance, a classifier derived from temporal models derived from subjects that have lost drug sensitivity or are in the process of loosing drug sensitivity as well as temporal models from subjects that exhibit drug sensitivity may be generated using the methods outlined herein and applied to the feature vector generated from the activation state data associated with the sample from the individual.

In other instances, the association value may be used to diagnose an individual as having a specific condition or disease state. For example, if the sample is derived from a individual who is suspected of having a hematological malignancy, activation state data associated with the sample from the individual can be transformed into a feature vector and subject to classifiers derived from temporal models derived from samples of individuals with different hematological malignancies (and grades thereof) as well as classifiers derived from temporal models derived from samples of normal individuals (i.e. not diagnosed with any disease conditions). A series of association values may be provided to create a profile that allows a physician to diagnose or give a prognosis to the individual based on the association between their activation state data and the temporal models of disease and normal profiles.

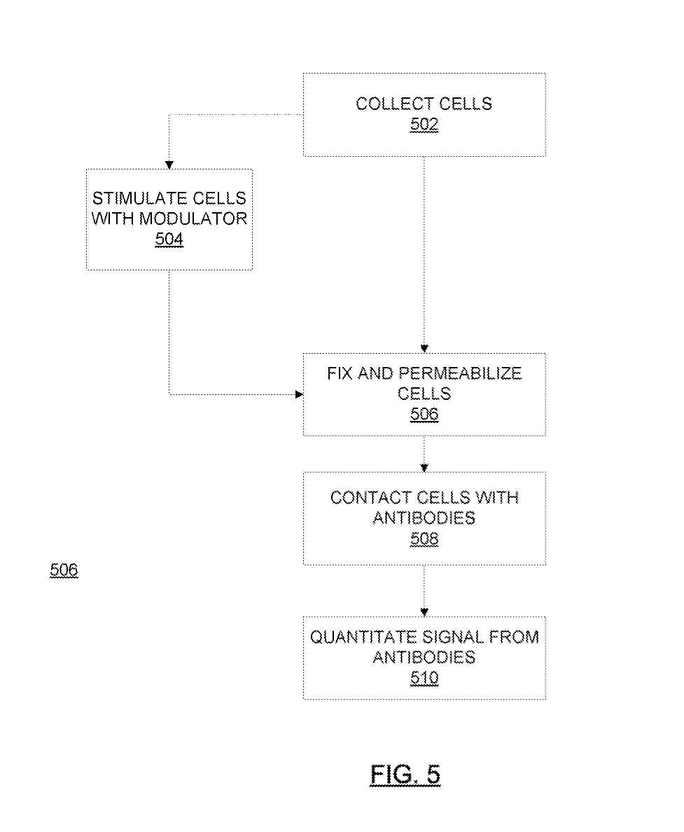

FIG. 5 illustrates a series of steps performed by a party to generate activation state data according to an embodiment of the present invention. In other embodiments, different or additional steps may be performed.

A party collects 502 a sample comprising a population of one or more cells. Before transmitting the cells for analysis a party may suspend the cells in a reagent or otherwise treat the cells to minimize damages. These reagents and treatments may be purchased from a central laboratory as a kit comprising protocols for collecting samples. Suitable methods for processing cell samples are outlined in Ser. No. 12/432,239, the entirety of which is incorporated herein for all purposes.

Alternately, the party can stimulate 504 the collected cells with a modulator. Example modulators are discussed below in the section titled “Modulators”. The party can purchase a modulator that has been validated by a central laboratory to produce standardized activation state data as part of a kit comprising protocols for stimulating cells. The party fixes and permeabilizes 506 the cells. If the third party has collected and stimulated the cells using a kit, the third party can fix and permeabilize 506 the collected cells according to protocols developed by the central laboratory to optimize and standardize these processes. The party contacts 508 the permeabilized cells with one or more antibodies. The party may purchase antibodies that have been validated by the central laboratory to produce standardized activation state data as part of a node kit comprising protocols for contact cells with antibodies. Kits and methods for generating standardized activation state data are outlined in

The party generates activation state data by quantitating 512 signal from the antibodies (i.e. activation level of one or more nodes) using any type of technique that is appropriate for single cell analysis including flow cytometry, laser cytometry and mass spectrometry. Prior to quantitating signal from the antibodies, the party may calibrate their flow cytometer or other instrument using a calibration kit developed by the central laboratory comprising reagents and protocols for instrument calibration. Suitable methods for standardizing flow cytometry data are outlined in U.S. Ser. No. 12/688,851, the entirety of which is incorporated herein for all purposes.

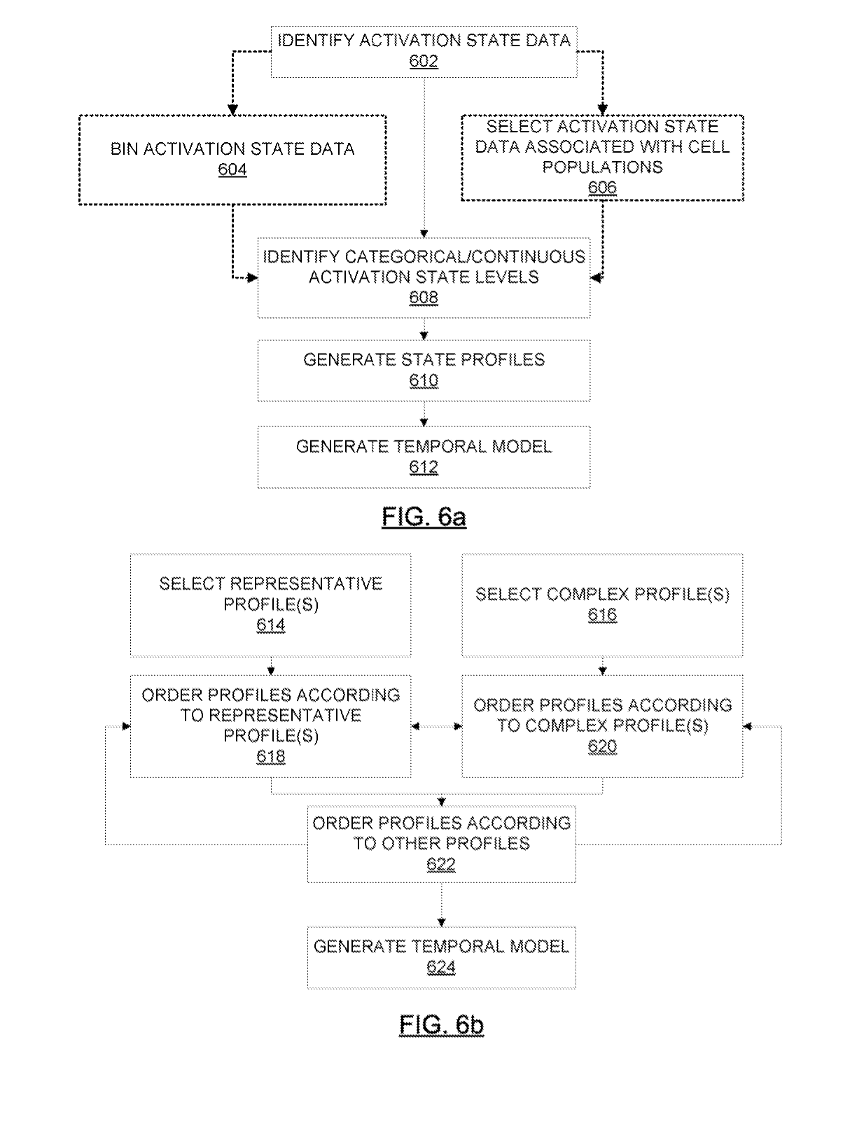

FIG. 6a illustrates a series of steps performed by the laboratory server 410 to generate temporal models. It should be appreciated that different embodiments of the present invention may perform different combinations of steps, in different orders.

The laboratory server 410 identifies 602 activation state data associated with a population of cells. Alternatively, the laboratory server 410 can select 606 activation state data association with a sub-population of cells and limit further analysis to the selected 606 sub-population of cells. Alternately, the laboratory server 410 can also bin 604 activation state data based on gating techniques, histograms and multi-resolution displays of data before proceeding to further steps.

The laboratory server 410 identifies 608 continuous and/or categorical activation states based on the activation state data. The laboratory server 410 associates the activation state data with a relative temporal value to generate 610 biological state profiles. The laboratory server 410 generates 612 a temporal model responsive to iteratively re-ordering the biological state profiles.

FIG. 6b illustrates alternative steps performed by the laboratory server 410 to generate temporal models. It should be appreciated that different embodiments of the present invention may perform different combinations of steps, in different orders.

In some embodiments, the laboratory server 410 can either select 614 one or more representative profile(s) or select 616 one or more complex profile(s). The laboratory server 410 then either orders 618 the profiles for the other activatable elements according to the representative profile or orders 620 the profile for the other activatable elements according to the complex profile. The laboratory server 410 iteratively orders profiles 622 according to other profiles, orders 620 profiles according to the complex profile and/or orders 618 profiles according to the representative profile(s) until an optimal set of profiles is achieved. The laboratory server 410 then generates 624 a temporal model based on the ordered profiles.

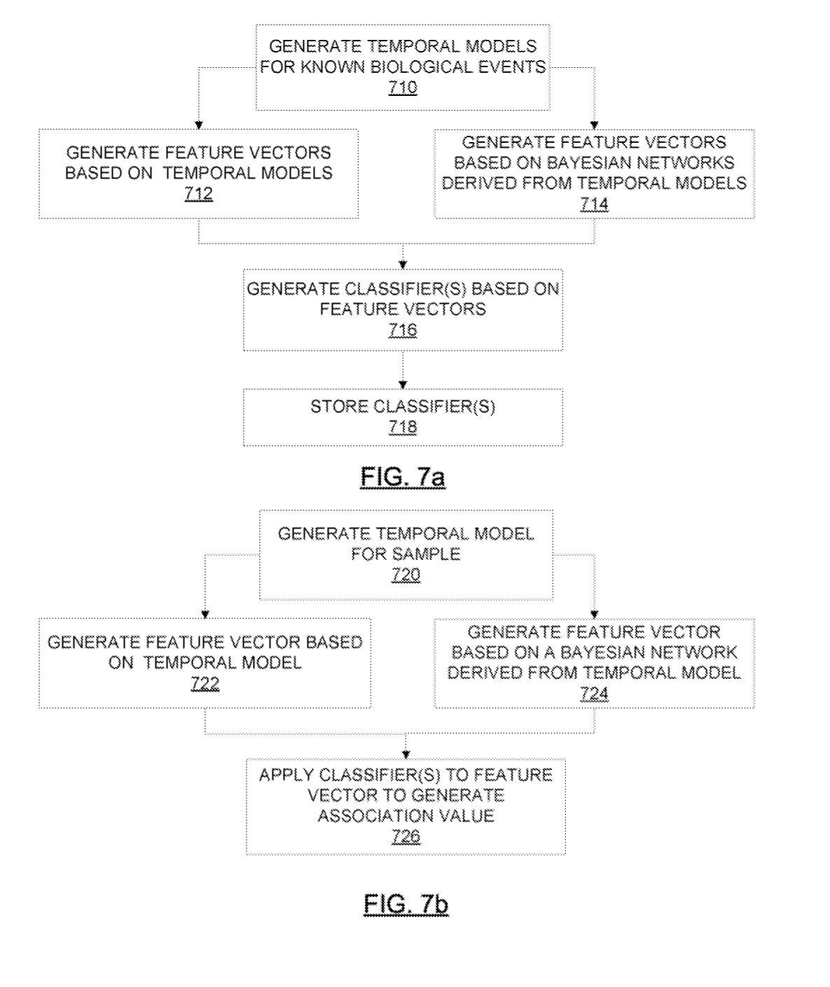

FIG. 7a illustrates alternate steps performed by the laboratory server 410 to generate and store classifiers. It should be appreciated that different embodiments of the present invention may perform different combinations of steps, in different orders.

The laboratory server 410 generates 710 a set of temporal models based on activation state data from a set of cell populations associated with one or more known biological events. The laboratory server 410 then generates 712 feature vectors based on the temporal models, where the feature vectors comprise descriptive metrics for the models. Alternately, the laboratory server 410 generates 714 feature vectors based on Bayesian networks generated for the model, where the feature vectors comprise a set of probabilities associated with arcs in the Bayesian network. The laboratory server 410 generates 716 a classifier based on the sets of feature vectors associated with known biological events. The laboratory server 410 stores 718 the classifier in the model classifier dataset 460.

FIG. 7b illustrates alternate steps performed by the laboratory server 410 to classify samples based on their activation state data. It should be appreciated that different embodiments of the present invention may perform different combinations of steps, in different orders.

The laboratory server 410 generates 720 a temporal model for the sample based on the activation state data associated with the sample. The laboratory server 410 generates 722 a feature vector for the temporal model, where the feature vector comprises descriptive metrics for the models. Alternately, the laboratory server 410 generates 724 a feature vector based on a Bayesian network derived from the model, where the feature vectors comprise a set of probabilities associated with arcs in the Bayesian network. The laboratory server 410 generates 726 one or more association values used to determine whether the sample is undergoing a biological event, by applying one or more classifiers to the feature vector, where the one or more classifiers are each associated with one or more known biological events. In some embodiments, the laboratory server 410 applies a threshold value to the one or more association values in order to determine whether the sample is associated with the one or more biological events.

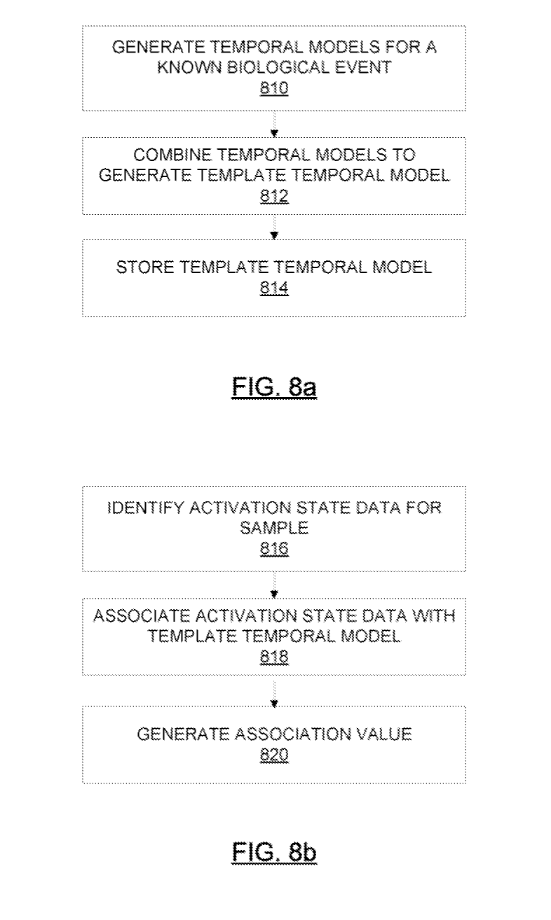

FIG. 8a illustrates steps performed by the laboratory server 410 to generate a template temporal model for a known biological event. It should be appreciated that different embodiments of the present invention may perform different combinations of steps, in different orders.

The laboratory server 410 generates 810 a set of temporal models based on activation state data from a set of cell populations associated with a known biological event. The laboratory server 410 combines 812 the set of temporal models to generate a template temporal model. The laboratory server 410 stores 814 the template temporal model in the temporal models dataset 455.

FIG. 8b illustrates steps performed by the laboratory server 410 to generate a template temporal model for a known biological event. It should be appreciated that different embodiments of the present invention may perform different combinations of steps, in different orders.

The laboratory server 410 identifies activation state data generated from a sample. The laboratory server 410 then associates 818 the activation state data with a template temporal model for a biological event. In some embodiments, the laboratory server 410 displays the activation data in association with a graphic representation of the template temporal model (e.g. on line plot of the template temporal model). In other embodiments, the laboratory server 410 associates 818 the activation state data with one or more biological states in the temporal model. In these embodiments, the laboratory server 410 generates 820 an association value that specifies the statistical correlation between the activation state data and the template temporal model and/or the likelihood that the sample is associated with the template temporal model. The association value can be used to determine whether the sample is in a biological state or biological event associated with the template temporal model.

FIG. 9 is a high-level block diagram illustrating a typical computer 900, which may be used as a client and/or the laboratory server 410. Illustrated are a processor 902 coupled to a bus 904. Also coupled to the bus 904 are a memory 906, a storage device 908, a keyboard 910, a graphics adapter 912, a pointing device 914, and a network adapter 916. A display 918 is coupled to the graphics adapter 912. The processor 902 may be any general purpose processor such as an INTEL x86 compatible-CPU. The storage device 908 is, in one embodiment, a hard disk drive but can also be any other device capable of storing data, such as a writeable compact disk (CD) or DVD, or a solidstate memory device. The memory 906 may be, for example, firmware, read-only memory (ROM), non-volatile random access memory (NVRAM), and/or RAM, and holds instructions and data used by the processor 902. The pointing device 914 may be a mouse, track ball, or other type of pointing device, and is used in combination with the keyboard 910 to input data into the computer 900. The graphics adapter 912 displays images and other information on the display 918. The network adapter 916 couples the computer 900 to a network (not pictured).

As is known in the art, the computer 900 is adapted to execute computer program modules. As used herein, the term “module” refers to computer program logic and/or data for providing the specified functionality, stored on a computer-readable storage medium and accessible by the processing elements of the computer 900. A module may be implemented in hardware, firmware, and/or software. In one embodiment, the modules are stored on the storage device 908, loaded into the memory 906, and executed by the processor 902.

### Modulators

A modulator can be an activator, an inhibitor or a compound capable of impacting cellular signaling networks. Modulators can take the form of a wide variety of environmental cues and inputs. In some embodiments, the modulator is selected from the group comprising: growth factors, cytokines, adhesion molecules, drugs, hormones, small molecules, polynucleotides, antibodies, natural compounds, lactones, chemotherapeutic agents, immune modulators, carbohydrates, proteases, ions, reactive oxygen species, radiation, physical parameters such as heat, cold, UV radiation, peptides, and protein fragments, either alone or in the context of cells, cells themselves, viruses, and biological and non-biological complexes (e.g. beads, plates, viral envelopes, antigen presentation molecules such as major histocompatibility complex). One exemplary set of modulators, includes but is not limited to SDF-1α, IFN-α, IFN-γ, IL-10, IL-6, IL-27, G-CSF, FLT-3L, IGF-1, M-CSF, SCF, PMA, Thapsigargin, H₂O₂, etoposide, AraC, daunorubicin, staurosporine, benzyloxycarbonyl-Val-Ala-Asp (OMe) fluoromethylketone (ZVAD), lenalidomide, EPO, azacitadine, decitabine, IL-3, IL-4, GM-CSF, EPO, LPS, TNF-α, and CD40L. In some embodiments, the modulator is an activator. In some embodiments the modulator is an inhibitor. In some embodiments, the modulators include growth factors, cytokines, chemokines, phosphatase inhibitors, and pharmacological reagents. The response panel is composed of at least one of: SDF-1α, IFN-α, IFN-γ, IL-10, IL-6, IL-27, G-CSF, FLT-3L, IGF-1, M-CSF, SCF, PMA, Thapsigargin, H₂O₂, etoposide, AraC, daunorubicin, staurosporine, benzyloxycarbonyl-Val-Ala-Asp (OMe) fluoromethylketone (ZVAD), lenalidomide, EPO, azacitadine, decitabine, IL-3, IL-4, GM-CSF, EPO, LPS, TNF-α, and CD40L.

In some embodiments, the methods and composition utilize a modulator. A modulator can be an activator, an inhibitor or a compound capable of impacting a cellular pathway. Modulators can take the form of environmental cues and inputs.

Modulation can be performed in a variety of environments. In some embodiments, cells are exposed to a modulator immediately after collection. In some embodiments where there is a mixed population of cells, purification of cells is performed after modulation. In some embodiments, whole blood is collected to which a modulator is added. In some embodiments, cells are modulated after processing for single cells or purified fractions of single cells. As an illustrative example, whole blood can be collected and processed for an enriched fraction of lymphocytes that is then exposed to a modulator. Modulation can include exposing cells to more than one modulator. For instance, in some embodiments, cells are exposed to at least 2, 3, 4, 5, 6, 7, 8, 9, or 10 modulators. See U.S. Patent Application 61/048,657, which is incorporated by reference.

In some embodiments, cells are cultured post collection in a suitable media before exposure to a modulator. In some embodiments, the media is a growth media. In some embodiments, the growth media is a complex media that may include serum. In some embodiments, the growth media comprises serum. In some embodiments, the serum is selected from the group consisting of fetal bovine serum, bovine serum, human serum, porcine serum, horse serum, and goat serum. In some embodiments, the serum level ranges from 0.0001% to 30%. In some embodiments, the growth media is a chemically defined minimal media and is without serum. In some embodiments, cells are cultured in a differentiating media.

Modulators include chemical and biological entities, and physical or environmental stimuli. Modulators can act extracellularly or intracellularly. Chemical and biological modulators include growth factors, cytokines, neurotransmitters, adhesion molecules, hormones, small molecules, inorganic compounds, polynucleotides, antibodies, natural compounds, lectins, lactones, chemotherapeutic agents, biological response modifiers, carbohydrate, proteases and free radicals. Modulators include complex and undefined biologic compositions that may comprise cellular or botanical extracts, cellular or glandular secretions, physiologic fluids such as serum, amniotic fluid, or venom. Physical and environmental stimuli include electromagnetic, ultraviolet, infrared or particulate radiation, redox potential and pH, the presence or absences of nutrients, changes in temperature, changes in oxygen partial pressure, changes in ion concentrations and the application of oxidative stress. Modulators can be endogenous or exogenous and may produce different effects depending on the concentration and duration of exposure to the single cells or whether they are used in combination or sequentially with other modulators. Modulators can act directly on the activatable elements or indirectly through the interaction with one or more intermediary biomolecule. Indirect modulation includes alterations of gene expression wherein the expressed gene product is the activatable element or is a modulator of the activatable element.

In some embodiments the modulator is selected from the group consisting of growth factors, cytokines, adhesion molecules, drugs, hormones, small molecules, polynucleotides, antibodies, natural compounds, lactones, chemotherapeutic agents, immune modulators, carbohydrates, proteases, ions, reactive oxygen species, peptides, and protein fragments, either alone or in the context of cells, cells themselves, viruses, and biological and non-biological complexes (e.g. beads, plates, viral envelopes, antigen presentation molecules such as major histocompatibility complex). In some embodiments, the modulator is a physical stimuli such as heat, cold, UV radiation, and radiation. Examples of modulators, include but are not limited to SDF-1α, IFN-α, IFN-γ, IL-10, IL-6, IL-27, G-CSF, FLT-3L, IGF-1, M-CSF, SCF, PMA, Thapsigargin, H₂O₂, etoposide, AraC, daunorubicin, staurosporine, benzyloxycarbonyl-Val-Ala-Asp (OMe) fluoromethylketone (ZVAD), lenalidomide, EPO, azacitadine, decitabine, IL-3, IL-4, GM-CSF, EPO, LPS, TNF-α, and CD40L.

In some embodiments, the modulator is an activator. In some embodiments the modulator is an inhibitor. In some embodiments, cells are exposed to one or more modulator. In some embodiments, cells are exposed to at least 2, 3, 4, 5, 6, 7, 8, 9, or 10 modulators. In some embodiments, cells are exposed to at least two modulators, wherein one modulator is an activator and one modulator is an inhibitor. In some embodiments, cells are exposed to at least 2, 3, 4, 5, 6, 7, 8, 9, or 10 modulators, where at least one of the modulators is an inhibitor.

In some embodiments, the cross-linker is a molecular binding entity. In some embodiments, the molecular is a monovalent, bivalent, or multivalent is made more multivalent by attachment to a solid surface or tethered on a nanoparticle surface to increase the local valency of the epitope binding domain.

In some embodiments, the inhibitor is an inhibitor of a cellular factor or a plurality of factors that participates in a cellular pathway (e.g. signaling cascade) in the cell. In some embodiments, the inhibitor is a phosphatase inhibitor. Examples of phosphatase inhibitors include, but are not limited to H₂O₂, siRNA, miRNA, Cantharidin, (−)-p-Bromotetramisole, Microcystin LR, Sodium Orthovanadate, Sodium Pervanadate, Vanadyl sulfate, Sodium oxodiperoxo(1,10-phenanthroline)vanadate, bis(maltolato)oxovanadium(IV), Sodium Molybdate, Sodium Perm olybdate, Sodium Tartrate, Imidazole, Sodium Fluoride, β-Glycerophosphate, Sodium Pyrophosphate Decahydrate, Calyculin A, Discodermia calyx, bpV(phen), mpV(pic), DMHV, Cypermethrin, Dephostatin, Okadaic Acid, NIPP-1, N-(9,10-Dioxo-9,10-dihydro-phenanthren-2-yl)-2,2-dimethyl-propionamide, α-Bromo-4-hydroxyacetophenone, 4-Hydroxyphenacyl Br, α-Bromo-4-methoxyacetophenone, 4-Methoxyphenacyl Br, α-Bromo-4-(carboxymethoxy)acetophenone, 4-(Carboxymethoxy)phenacyl Br, and bis(4-Trifluoromethylsulfonamidophenyl)-1,4-diisopropylbenzene, phenylarsine oxide, Pyrrolidine Dithiocarbamate, and Aluminium fluoride. In some embodiments, the phosphatase inhibitor is H₂O₂.

In some embodiments, the inhibitor is an inhibitor of a cellular factor or a plurality of factors that participates in a signaling cascade in the cell. In some embodiments, the inhibitor is a phosphatase inhibitor. Examples of phosphatase inhibitors include, but are not limited to H_{2O2}, siRNA, miRNA, Cantharidin, (−)-p-Bromotetramisole, Microcystin LR, Sodium Orthovanadate, Sodium Pervanadate, Vanadyl sulfate, Sodium oxodiperoxo(1,10-phenanthroline)vanadate, bis(maltolato)oxovanadium(IV), Sodium Molybdate, Sodium Perm olybdate, Sodium Tartrate, Imidazole, Sodium Fluoride, β-Glycerophosphate, Sodium Pyrophosphate Decahydrate, Calyculin A, Discodermia calyx, bpV(phen), mpV(pic), DMHV, Cypermethrin, Dephostatin, Okadaic Acid, NIPP-1, N-(9,10-Dioxo-9,10-dihydro-phenanthren-2-yl)-2,2-dimethyl-propionamide, α-Bromo-4-hydroxyacetophenone, 4-Hydroxyphenacyl Br, α-Bromo-4-methoxyacetophenone, 4-Methoxyphenacyl Br, α-Bromo-4-(carboxymethoxy)acetophenone, 4-(Carboxymethoxy)phenacyl Br, and bis(4-Trifluoromethylsulfonamidophenyl)-1,4-diisopropylbenzene, phenylarsine oxide, Pyrrolidine Dithiocarbamate, and Aluminium fluoride. In some embodiments, the phosphatase inhibitor is H₂O2.

### Activatable Elements

In some embodiments, the invention is directed to methods for determining the activation level (i.e. the quantity) of one or more activatable elements in a cell upon treatment with one or more modulators. The activation of an activatable element in the cell upon treatment with one or more modulators can reveal operative pathways in a condition that can then be used, e.g., as an indicator to predict the course of the condition, to identify risk group, to predict an increased risk of developing secondary complications or suffering harmful side effects, to choose a therapy for an individual, to predict response to a therapy for an individual, to determine the efficacy of a therapy in an individual, and to determine the prognosis for an individual.

In some embodiments, the activation level of an activatable element in a cell is determined by contacting the cell with at least 2, 3, 4, 5, 6, 7, 8, 9, or 10 modulators. In some embodiments, the activation level of an activatable element in a cell is determined by contacting the cell with at least 2, 3, 4, 5, 6, 7, 8, 9, or 10 modulators where at least one of the modulators is an inhibitor. In some embodiments, the activation level of an activatable element in a cell is determined by contacting the cell with an inhibitor and a modulator, where the modulator can be an inhibitor or an activator. In some embodiments, the activation level of an activatable element in a cell is determined by contacting the cell with an inhibitor and an activator. In some embodiments, the activation level of an activatable element in a cell is determined by contacting the cell with two or more modulators.

In some embodiments, a phenotypic profile of a population of cells is determined by measuring the activation level of an activatable element when the population of cells is exposed to a plurality of modulators in separate cultures. In some embodiments, the modulators include H₂O₂, PMA, SDF1α, CD40L, IGF-1, IL-7, IL-6, IL-10, IL-27, IL-4, IL-2, IL-3, thapsigardin and/or a combination thereof. For instance a population of cells can be exposed to one or more, all or a combination of the following combination of modulators: H₂O₂; PMA; SDF1α; CD40L; IGF-1; IL-7; IL-6; IL-10; IL-27; IL-4; IL-2; IL-3; thapsigardin. In some embodiments, the phenotypic profile of the population of cells is used to classify the population as described herein.

The methods and compositions of the invention may be employed to examine and profile the activation level of any activatable element in a cellular pathway, or collections of such activatable elements. Single or multiple distinct pathways may be profiled (sequentially or simultaneously), or subsets of activatable elements within a single pathway or across multiple pathways may be examined (again, sequentially or simultaneously).

As will be appreciated by those in the art, a wide variety of activation events can find use in the present invention. In general, the basic requirement is that the activation results in a change in the activatable element that is quantifiable by some indication (termed an “activation state indicator”), preferably by altered binding of a labeled binding element or by changes in detectable biological activities (e.g., the activated state has an enzymatic activity which can be measured and compared to a lack of activity in the non-activated state, or the cell cycle arrests at a certain point, resulting in a specific level of DNA accumulation).

The activation level of an individual activatable element represents a relative quantity of the activation element. The activation levels can be represented into numeric values or discretized into categorical activation states such as high activation/low activation/no activation or an “on or off” state. As an illustrative example, and without intending to be limited to any mechanism or process, an individual phosphorylatable site on a protein can activate or deactivate the protein. Additionally, phosphorylation of an adapter protein may promote its interaction with other components/proteins of distinct cellular signaling pathways. The terms “on” and “off” when applied to an activatable element that is a part of a cellular constituent, are used here to describe the state of the activatable element, and not the overall state of the cellular constituent of which it is a part. Typically, a cell possesses a plurality of a particular protein or other constituent with a particular activatable element and this plurality of proteins or constituents usually has some proteins or constituents whose individual activatable element is in the on state and other proteins or constituents whose individual activatable element is in the off state. Since the activation level of each activatable element is measured through the use of a binding element that recognizes a specific activation state, only those activatable elements in the specific activation state recognized by the binding element, representing some fraction of the total number of activatable elements, will be bound by the binding element to generate a measurable signal. The measurable signal corresponding to the summation of individual activatable elements of a particular type that are activated in a single cell is the “activation level” for that activatable element in that cell.

Activation levels (i.e. quantity determined based on antibody signal) for a particular activatable element may vary among individual cells so that when a plurality of cells is analyzed, the activation levels follow a distribution. The distribution may be a normal distribution, also known as a Gaussian distribution, or it may be of another type. Different populations of cells may have different distributions of activation levels that can then serve to distinguish between the populations.

In some embodiments, the basis for classifying cells is that the distribution of activation levels for one or more specific activatable elements will differ among different phenotypes. A certain activation level, or more typically a range of activation levels for one or more activatable elements seen in a cell or a population of cells, is indicative that that cell or population of cells belongs to a distinctive phenotype. Other measurements, such as cellular levels (e.g., expression levels) of biomolecules that may not contain activatable elements, may also be used to classify cells in addition to activation levels of activatable elements; it will be appreciated that these cellular levels also will follow a distribution, similar to activatable elements. Thus, the activation level or levels of one or more activatable elements, optionally in conjunction with levels of one or more cellular levels of biomolecules that may or may not contain activatable elements, of cell or a population of cells may be used to classify a cell or a population of cells into a class. Once the activation level of intracellular activatable elements of individual single cells is known they can be placed into one or more classes, e.g., a class that corresponds to a phenotype. A class encompasses a class of cells wherein every cell has the same or substantially the same known activation level, or range of activation levels, of one or more intracellular activatable elements. For example, if the activation levels of five intracellular activatable elements are analyzed, predefined classes of cells that encompass one or more of the intracellular activatable elements can be constructed based on the activation level, or ranges of the activation levels, of each of these five elements. It is understood that activation levels can exist as a distribution and that an activation level of a particular element used to classify a cell may be a particular point on the distribution but more typically may be a portion of the distribution.

In addition to activation levels of intracellular activatable elements, levels of intracellular or extracellular biomolecules, e.g., proteins, may be used alone or in combination with activation levels of activatable elements to classify cells. Further, additional cellular elements, e.g., biomolecules or molecular complexes such as RNA, DNA, carbohydrates, metabolites, and the like, may be used in conjunction with activatable states or expression levels in the classification of cells encompassed here.

In some embodiments, other characteristics that affect the status of a cellular constituent may also be used to classify a cell. Examples include the translocation of biomolecules or changes in their turnover rates and the formation and disassociation of complexes of biomolecule. Such complexes can include multi-protein complexes, multi-lipid complexes, homo- or hetero-dimers or oligomers, and combinations thereof. Other characteristics include proteolytic cleavage, e.g. from exposure of a cell to an extracellular protease or from the intracellular proteolytic cleavage of a biomolecule.

Additional elements may also be used to classify a cell, such as the expression level of extracellular or intracellular markers, nuclear antigens, enzymatic activity, protein expression and localization, cell cycle analysis, chromosomal analysis, cell volume, and morphological characteristics like granularity and size of nucleus or other distinguishing characteristics. For example, B cells can be further subdivided based on the expression of cell surface markers such as CD19, CD20, CD22 or CD23.

Alternatively, predefined classes of cells can be aggregated or grouped based upon shared characteristics that may include inclusion in one or more additional predefined class or the presence of extracellular or intracellular markers, similar gene expression profile, nuclear antigens, enzymatic activity, protein expression and localization, cell cycle analysis, chromosomal analysis, cell volume, and morphological characteristics like granularity and size of nucleus or other distinguishing cellular characteristics.

In some embodiments, the biological state of one or more cells is determined by examining and profiling the activation level of one or more activatable elements in a cellular pathway. In some embodiments, a cell is classified according to the activation level of a plurality of activatable elements. In some embodiments, a hematopoietic cell is classified according to the activation levels of a plurality of activatable elements. In some embodiments, 1, 2, 3, 4, 5, 6, 7, 8, 9, 10 or more activatable elements may be analysed in a cell signaling pathway. In some embodiments, the activation levels of one or more activatable elements of a hematopoietic cell are correlated with a condition.

In some embodiments, the activation level of one or more activatable elements in single cells in the sample is determined. Cellular constituents that may include activatable elements include without limitation proteins, carbohydrates, lipids, nucleic acids and metabolites. The activatable element may be a portion of the cellular constituent, for example, an amino acid residue in a protein that may undergo phosphorylation, or it may be the cellular constituent itself, for example, a protein that is activated by translocation, change in conformation (due to, e.g., change in pH or ion concentration), by proteolytic cleavage, degradation through ubiquitination and the like. Upon activation, a change occurs to the activatable element, such as covalent modification of the activatable element (e.g., binding of a molecule or group to the activatable element, such as phosphorylation) or a conformational change. Such changes generally contribute to changes in particular biological, biochemical, or physical properties of the cellular constituent that contains the activatable element. The state of the cellular constituent that contains the activatable element is determined to some degree, though not necessarily completely, by the state of a particular activatable element of the cellular constituent. For example, a protein may have multiple activatable elements, and the particular activation levels of these elements may overall determine the activation state of the protein; the state of a single activatable element is not necessarily determinative. Additional factors, such as the binding of other proteins, pH, ion concentration, interaction with other cellular constituents, and the like, can also affect the state of the cellular constituent.

In some embodiments, the activation levels of a plurality of intracellular activatable elements in single cells are determined. In some embodiments, at least about 2, 3, 4, 5, 6, 7, 8, 9, or more than 10 intracellular activatable elements are determined.

Activation levels of activatable elements may result from chemical additions or modifications of biomolecules and include biochemical processes such as glycosylation, phosphorylation, acetylation, methylation, biotinylation, glutamylation, glycylation, hydroxylation, isomerization, prenylation, myristoylation, lipoylation, phosphopantetheinylation, sulfation, ISGylation, nitrosylation, palmitoylation, SUMOylation, ubiquitination, neddylation, citrullination, amidation, and disulfide bond formation, disulfide bond reduction. Other possible chemical additions or modifications of biomolecules include the formation of protein carbonyls, direct modifications of protein side chains, such as o-tyrosine, chloro-, nitrotyrosine, and dityrosine, and protein adducts derived from reactions with carbohydrate and lipid derivatives. Other modifications may be non-covalent, such as binding of a ligand or binding of an allosteric modulator.

One example of a covalent modification is the substitution of a phosphate group for a hydroxyl group in the side chain of an amino acid (phosphorylation). A wide variety of proteins are known that recognize specific protein substrates and catalyze the phosphorylation of serine, threonine, or tyrosine residues on their protein substrates. Such proteins are generally termed “kinases.” Substrate proteins that are capable of being phosphorylated are often referred to as phosphoproteins (after phosphorylation). Once phosphorylated, a substrate phosphoprotein may have its phosphorylated residue converted back to a hydroxyl one by the action of a protein phosphatase that specifically recognizes the substrate protein. Protein phosphatases catalyze the replacement of phosphate groups by hydroxyl groups on serine, threonine, or tyrosine residues. Through the action of kinases and phosphatases a protein may be reversibly phosphorylated on a multiplicity of residues and its activity may be regulated thereby. Thus, the presence or absence of one or more phosphate groups in an activatable protein is one readout in the present invention.

Another example of a covalent modification of an activatable protein is the acetylation of histones. Through the activity of various acetylases and deacetlylases the DNA binding function of histone proteins is tightly regulated. Furthermore, histone acetylation and histone deactelyation have been linked with malignant progression. See Nature, 429: 457-63, 2004.

Another form of activation involves cleavage of the activatable element. For example, one form of protein regulation involves proteolytic cleavage of a peptide bond. While random or misdirected proteolytic cleavage may be detrimental to the activity of a protein, many proteins are activated by the action of proteases that recognize and cleave specific peptide bonds. Many proteins derive from precursor proteins, or pro-proteins, which give rise to a mature isoform of the protein following proteolytic cleavage of specific peptide bonds. Many growth factors are synthesized and processed in this manner, with a mature isoform of the protein typically possessing a biological activity not exhibited by the precursor form. Many enzymes are also synthesized and processed in this manner, with a mature isoform of the protein typically being enzymatically active, and the precursor form of the protein being enzymatically inactive. This type of regulation is generally not reversible. Accordingly, to inhibit the activity of a proteolytically activated protein, mechanisms other than “reattachment” must be used. For example, many proteolytically activated proteins are relatively short-lived proteins, and their turnover effectively results in deactivation of the signal. Inhibitors may also be used. Among the enzymes that are proteolytically activated are serine and cysteine proteases, including cathepsins and caspases respectively.

In one embodiment, the activatable enzyme is a caspase. The caspases are an important class of proteases that mediate programmed cell death (referred to in the art as “apoptosis”). Caspases are constitutively present in most cells, residing in the cytosol as a single chain proenzyme. These are activated to fully functional proteases by a first proteolytic cleavage to divide the chain into large and small caspase subunits and a second cleavage to remove the N-terminal domain. The subunits assemble into a tetramer with two active sites (Green, Cell 94:695-698, 1998). Many other proteolytically activated enzymes, known in the art as “zymogens,” also find use in the instant invention as activatable elements.

In an alternative embodiment the activation of the activatable element involves prenylation of the element. By “prenylation”, and grammatical equivalents used herein, is meant the addition of any lipid group to the element. Common examples of prenylation include the addition of farnesyl groups, geranylgeranyl groups, myristoylation and palmitoylation. In general these groups are attached via thioether linkages to the activatable element, although other attachments may be used.

In alternative embodiment, activation of the activatable element is detected as intermolecular clustering of the activatable element. By “clustering” or “multimerization”, and grammatical equivalents used herein, is meant any reversible or irreversible association of one or more signal transduction elements. Clusters can be made up of 2, 3, 4, etc., elements. Clusters of two elements are termed dimers. Clusters of 3 or more elements are generally termed oligomers, with individual numbers of clusters having their own designation; for example, a cluster of 3 elements is a trimer, a cluster of 4 elements is a tetramer, etc.

Clusters can be made up of identical elements or different elements. Clusters of identical elements are termed “homo” dimers, while clusters of different elements are termed “hetero” clusters. Accordingly, a cluster can be a homodimer, as is the case for the β₂-adrenergic receptor.

Alternatively, a cluster can be a heterodimer, as is the case for GABA_{B-R}. In other embodiments, the cluster is a homotrimer, as in the case of TNFα, or a heterotrimer such the one formed by membrane-bound and soluble CD95 to modulate apoptosis. In further embodiments the cluster is a homo-oligomer, as in the case of Thyrotropin releasing hormone receptor, or a hetero-oligomer, as in the case of TGFβ1.

In one embodiment, the activation or signaling potential of elements is mediated by clustering, irrespective of the actual mechanism by which the element's clustering is induced. For example, elements can be activated to cluster a) as membrane bound receptors by binding to ligands (ligands including both naturally occurring or synthetic ligands), b) as membrane bound receptors by binding to other surface molecules, or c) as intracellular (non-membrane bound) receptors binding to ligands.

In one embodiment the activatable elements are membrane bound receptor elements that cluster upon ligand binding such as cell surface receptors. As used herein, “cell surface receptor” refers to molecules that occur on the surface of cells, interact with the extracellular environment, and transmit or transduce (through signals) the information regarding the environment intracellularly in a manner that may modulate cellular activity directly or indirectly, e.g., via intracellular second messenger activities or transcription of specific promoters, resulting in transcription of specific genes. One class of receptor elements includes membrane bound proteins, or complexes of proteins, which are activated to cluster upon ligand binding. As is known in the art, these receptor elements can have a variety of forms, but in general they comprise at least three domains. First, these receptors have a ligand-binding domain, which can be oriented either extracellularly or intracellularly, usually the former. Second, these receptors have a membrane-binding domain (usually a transmembrane domain), which can take the form of a seven pass transmembrane domain (discussed below in connection with G-protein-coupled receptors) or a lipid modification, such as myristylation, to one of the receptor's amino acids which allows for membrane association when the lipid inserts itself into the lipid bilayer. Finally, the receptor has an signaling domain, which is responsible for propagating the downstream effects of the receptor.

Examples of such receptor elements include hormone receptors, steroid receptors, cytokine receptors, such as IL1-α, IL-β, IL-2, IL-3, IL-4, IL-5, IL-6, IL-7, IL-8, IL-9, IL-10. IL-12, IL-15, IL-18, IL-21, CCR5, CCR7, CCR-1-10, CCL20, chemokine receptors, such as CXCR4, adhesion receptors and growth factor receptors, including, but not limited to, PDGF-R (platelet derived growth factor receptor), EGF-R (epidermal growth factor receptor), VEGF-R (vascular endothelial growth factor), uPAR (urokinase plasminogen activator receptor), ACHR (acetylcholine receptor), IgE-R (immunoglobulin E receptor), estrogen receptor, thyroid hormone receptor, integrin receptors (β1, β2, β3, β4, β5, β6, α1, α2, α3, α4, α5, α6), MAC-1 (β2 and cd11b), αVβ33, opioid receptors (mu and kappa), FC receptors, serotonin receptors (5-HT, 5-HT6, 5-HT7), β-adrenergic receptors, insulin receptor, leptin receptor, TNF receptor (tissue-necrosis factor), statin receptors, FAS receptor, BAFF receptor, FLT3 LIGAND receptor, GMCSF receptor, and fibronectin receptor.

In one embodiment the activatable element is a cytokine receptor. Cytokines are a family of soluble mediators of cell-to-cell communication that includes interleukins, interferons, and colony-stimulating factors. The characteristic features of cytokines lie in their pleiotropy and functional redundancy. Most of the cytokine receptors that constitute distinct superfamilies do not possess intrinsic protein tyrosine kinase domains, yet receptor stimulation usually invokes rapid tyrosine phosphorylation of intracellular proteins, including the receptors themselves. Many members of the cytokine receptor superfamily activate the Jak protein tyrosine kinase family, with resultant phosphorylation of the STAT family of transcription factors. IL-2, IL-4, IL-7 and Interferon γ have all been shown to activate Jak kinases (Frank et al. Proc. Natl. Acad. Sci. USA 92: 7779-7783, 1995); Scharfe et al. Blood 86:2077-2085, 1995); (Bacon et al. Proc. Natl. Acad. Sci. USA 92: 7307-7311, 1995); and (Sakatsume et al. J. Biol. Chem. 270: 17528-17534, 1995). Events downstream of Jak phosphorylation have also been elucidated. For example, exposure of T lymphocytes to IL-2 has been shown to lead to the phosphorylation of signal transducers and activators of transcription (STAT) proteins STAT1α, STAT1β, and STAT3, as well as of two STAT-related proteins, p94 and p95. The STAT proteins translocate to the nucleus and bind to a specific DNA sequence, thus suggesting a mechanism by which IL-2 may activate specific genes involved in immune cell function (Frank et al. supra). Jak3 is associated with the gamma chain of the IL-2, IL-4, and IL-7 cytokine receptors (Fujii et al. Proc. Natl. Acad. Sci. 92: 5482-5486, 1995) and (Musso et al. J. Exp. Med. 181: 1425-1431, 1995). The Jak kinases have been shown to be activated by numerous ligands that signal via cytokine receptors such as, growth hormone, erythropoietin and IL-6 (Kishimoto Stem cells Suppl. 12: 37-44, 1994). Preferred activatable elements are selected from the group p-STAT1, p-STAT3, p-STATS, p-STAT6, p-PLCγ2, p-S6, pAkt, p-Erk, p-CREB, p-38, and NF-KBp-65.

In one embodiment the activatable element is a member of the nerve growth factor receptor superfamily, such as the tumor necrosis factor alpha receptor. Tumor necrosis factor α (TNF-α or TNF-alpha) is a pleiotropic cytokine that is primarily produced by activated macrophages and lymphocytes but is also expressed in endothelial cells and other cell types. TNF-alpha is a major mediator of inflammatory, immunological, and pathophysiological reactions. (Grell, M., et al., Cell, 83:793-802, 1995). Two distinct forms of TNF exist, a 26 kDa membrane expressed form and the soluble 17 kDa cytokine which is derived from proteolytic cleavage of the 26 kDa form. The soluble TNF polypeptide is 157 amino acids long and is the primary biologically active molecule.

TNF-alpha exerts its biological effects through interaction with high-affinity cell surface receptors. Two distinct membrane TNF-alpha receptors have been cloned and characterized. These are a 55 kDa species, designated p55 TNF-R and a 75 kDa species designated p75 TNF-R (Corcoran. A. E., et al., Eur. J. Biochem., 223: 831-840, 1994). The two TNF receptors exhibit 28% similarity at the amino acid level. This is confined to the extracellular domain and consists of four repeating cysteine-rich motifs, each of approximately 40 amino acids. Each motif contains four to six cysteines in conserved positions. Dayhoff analysis shows the greatest intersubunit similarity among the first three repeats in each receptor. This characteristic structure is shared with a number of other receptors and cell surface molecules, which comprise the TNF-R/nerve growth factor receptor superfamily (Corcoran. A. E., et al., Eur. J. Biochem., 223: 831-840, 1994).

TNF signaling is initiated by receptor clustering, either by the trivalent ligand TNF or by cross-linking monoclonal antibodies (Vandevoorde, V., et al., J. Cell Biol., 137: 1627-1638, 1997). Crystallographic studies of TNF and the structurally related cytokine, lymphotoxin (LT), have shown that both cytokines exist as homotrimers, with subunits packed edge to edge in threefold symmetry. Structurally, neither TNF nor LT reflect the repeating pattern of the their receptors. Each monomer is cone shaped and contains two hydrophilic loops on opposite sides of the base of the cone. Recent crystal structure determination of a p55 soluble TNF-R/LT complex has confirmed the hypothesis that loops from adjacent monomers join together to form a groove between monomers and that TNF-R binds in these grooves (Corcoran. A. E., et al., Eur. J. Biochem., 223: 831-840, 1994).

In one embodiment, the activatable element is a receptor tyrosine kinase. The receptor tyrosine kinases can be divided into subgroups on the basis of structural similarities in their extracellular domains and the organization of the tyrosine kinase catalytic region in their cytoplasmic domains. Sub-groups I (epidermal growth factor (EGF) receptor-like), II (insulin receptor-like) and the EPH/ECK family contain cysteine-rich sequences (Hirai et al., (1987) Science 238:1717-1720 and Lindberg and Hunter, (1990) Mol. Cell. Biol. 10:6316-6324). The functional domains of the kinase region of these three classes of receptor tyrosine kinases are encoded as a contiguous sequence (Hanks et al. (1988) Science 241:42-52). Subgroups III (platelet-derived growth factor (PDGF) receptor-like) and IV (the fibro-blast growth factor (FGF) receptors) are characterized as having immunoglobulin (Ig)-like folds in their extracellular domains, as well as having their kinase domains divided in two parts by a variable stretch of unrelated amino acids (Yanden and Ullrich (1988) supra and Hanks et al. (1988) supra).

The family with the largest number of known members is the Eph family (with the first member of the family originally isolated from an erythropoietin producing hepatocellular carcinoma cell line). Since the description of the prototype, the Eph receptor (Hirai et al. (1987) Science 238:1717-1720), sequences have been reported for at least ten members of this family, not counting apparently orthologous receptors found in more than one species. Additional partial sequences, and the rate at which new members are still being reported, suggest the family is even larger (Maisonpierre et al. (1993) Oncogene 8:3277-3288; Andres et al. (1994) Oncogene 9:1461-1467; Henkemeyer et al. (1994) Oncogene 9:1001-1014; Ruiz et al. (1994) Mech. Dev. 46:87-100; Xu et al. (1994) Development 120:287-299; Zhou et al. (1994) J. Neurosci. Res. 37:129-143; and references in Tuzi and Gullick (1994) Br. J. Cancer 69:417-421). Remarkably, despite the large number of members in the Eph family, all of these molecules were identified as orphan receptors without known ligands.

As used herein, the terms “Eph receptor” or “Eph-type receptor” refer to a class of receptor tyrosine kinases, comprising at least eleven paralogous genes, though many more orthologs exist within this class, e.g. homologs from different species. Eph receptors, in general, are a discrete group of receptors related by homology and easily recognizable, e.g., they are typically characterized by an extracellular domain containing a characteristic spacing of cysteine residues near the N-terminus and two fibronectin type III repeats (Hirai et al. (1987) Science 238:1717-1720; Lindberg et al. (1990) Mol. Cell Biol. 10:6316-6324; Chan et al. (1991) Oncogene 6:1057-1061; Maisonpierre et al. (1993) Oncogene 8:3277-3288; Andres et al. (1994) Oncogene 9:1461-1467; Henkemeyer et al. (1994) Oncogene 9:1001-1014; Ruiz et al. (1994) Mech. Dev. 46:87-100; Xu et al. (1994) Development 120:287-299; Zhou et al. (1994) J. Neurosci. Res. 37:129-143; and references in Tuzi and Gullick (1994) Br. J. Cancer 69:417-421). Exemplary Eph receptors include the eph, elk, eck, sek, mek4, hek, hek2, eek, erk, tyro1, tyro4, tyro5, tyro6, tyro111, cek4, cek5, cek6, cek7, cek8, cek9, cek10, bsk, rtk1, rtk2, rtk3, myk1, myk2, ehk1, ehk2, pagliaccio, htk, erk and nuk receptors.

In another embodiment the receptor element is a member of the hematopoietin receptor superfamily. Hematopoietin receptor superfamily is used herein to define single-pass transmembrane receptors, with a three-domain architecture: an extracellular domain that binds the activating ligand, a short transmembrane segment, and a domain residing in the cytoplasm. The extracellular domains of these receptors have low but significant homology within their extracellular ligand-binding domain comprising about 200-210 amino acids. The homologous region is characterized by four cysteine residues located in the N-terminal half of the region, and a Trp-Ser-X-Trp-Ser (WSXWS) motif located just outside the membrane-spanning domain. Further structural and functional details of these receptors are provided by Cosman, D. et al., (1990). The receptors of IL-1, IL-2, IL-3, IL-4, IL-5, IL-6, IL-7, prolactin, placental lactogen, growth hormone GM-CSF, G-CSF, M-CSF and erythropoietin have, for example, been identified as members of this receptor family.

In a further embodiment, the receptor element is an integrin other than Leukocyte Function Antigen-1 (LFA-1). Members of the integrin family of receptors function as heterodimers, composed of various α and β subunits, and mediate interactions between a cell's cytoskeleton and the extracellular matrix. (Reviewed in, Giancotti and Ruoslahti, Science 285, 13 Aug. 1999). Different combinations of the α and β subunits give rise to a wide range of ligand specificities, which may be increased further by the presence of cell-type-specific factors. Integrin clustering is know to activate a number of intracellular signals, such as RAS, MAP kinase, and phosphotidylinosital-3-kinase. In one embodiment the receptor element is a heterodimer (other than LFA-1) composed of a β integrin and an α integrin chosen from the following integrins; β1, β2, β3, β4, β5, β6, α1, α2, α3, α4, α5, and α6, or is MAC-1 (β2 and cd11b), or αVβ3.

In one embodiment the element is an intracellular adhesion molecule (ICAM). ICAMs -1, -2, and -3 are cellular adhesion molecules belonging to the immunogloblin superfamily. Each of these receptors has a single membrane-spanning domain and all bind to β2 integrins via extracellular binding domains similar in structure to Ig-loops. (Signal Transduction, Gomperts, et al., eds, Academic or government Press Publishers, 2002, Chapter 14, pp 318-319).

In another embodiment the activatable elements cluster for signaling by contact with other surface molecules. In contrast to the receptors discussed above, these elements cluster for signaling by contact with other surface molecules, and generally use molecules presented on the surface of a second cell as ligands. Receptors of this class are important in cell-cell interactions, such mediating cell-to-cell adhesion and immunorecognition.

Examples of such receptor elements are CD3 (T cell receptor complex), BCR (B cell receptor complex), CD4, CD28, CD80, CD86, CD54, CD102, CD50 and ICAMs 1, 2 and 3.

In one embodiment the receptor element is a T cell receptor complex (TCR). TCRs occur as either of two distinct heterodimers, αβ, or γξ both of which are expressed with the non-polymorphic CD3 polypeptides γ, Σ, ε, ξ. The CD3 polypeptides, especially ξ and its variants, are critical for intracellular signaling. The αγ TCR heterodimer expressing cells predominate in most lymphoid compartments and are responsible for the classical helper or cytotoxic T cell responses. Im most cases, the αβ TCR ligand is a peptide antigen bound to a class I or a class II MHC molecule (Fundamental Immunology, fourth edition, W. E. Paul, ed., Lippincott-Raven Publishers, 1999, Chapter 10, pp 341-367).

In another embodiment, the activatable element is a member of the large family of G-protein-coupled receptors. It has recently been reported that a G-protein-coupled receptors are capable of clustering. (Kroeger, et al., J Biol Chem 276:16, 12736-12743, Apr. 20, 2001; Bai, et al., J Biol Chem 273:36, 23605-23610, Sep. 4, 1998; Rocheville, et al., J Biol Chem 275 (11), 7862-7869, Mar. 17, 2000). As used herein G-protein-coupled receptor, and grammatical equivalents thereof, refers to the family of receptors that bind to heterotrimeric “G proteins.” Many different G proteins are known to interact with receptors. G protein signaling systems include three components: the receptor itself, a GTP-binding protein (G protein), and an intracellular target protein. The cell membrane acts as a switchboard. Messages arriving through different receptors can produce a single effect if the receptors act on the same type of G protein. On the other hand, signals activating a single receptor can produce more than one effect if the receptor acts on different kinds of G proteins, or if the G proteins can act on different effectors.

In their resting state, the G proteins, which consist of alpha (α), beta (β) and gamma (γ) subunits, are complexed with the nucleotide guanosine diphosphate (GDP) and are in contact with receptors. When a hormone or other first messenger binds to a receptor, the receptor changes conformation and this alters its interaction with the G protein. This spurs a subunit to release GDP, and the more abundant nucleotide guanosine triphosphate (GTP), replaces it, activating the G protein. The G protein then dissociates to separate the α subunit from the still complexed beta and gamma subunits. Either the Gα subunit, or the Gβγ complex, depending on the pathway, interacts with an effector. The effector (which is often an enzyme) in turn converts an inactive precursor molecule into an active “second messenger,” which may diffuse through the cytoplasm, triggering a metabolic cascade. After a few seconds, the Gα converts the GTP to GDP, thereby inactivating itself. The inactivated Gα may then reassociate with the Gβγ complex.

Hundreds, if not thousands, of receptors convey messages through heterotrimeric G proteins, of which at least 17 distinct forms have been isolated. Although the greatest variability has been seen in a subunit, several different β and γ structures have been reported. There are, additionally, many different G protein-dependent effectors.

Most G protein-coupled receptors are comprised of a single protein chain that passes through the plasma membrane seven times. Such receptors are often referred to as seven-transmembrane receptors (STRs). More than a hundred different STRs have been found, including many distinct receptors that bind the same ligand, and there are likely many more STRs awaiting discovery.

In addition, STRs have been identified for which the natural ligands are unknown; these receptors are termed “orphan” G protein-coupled receptors, as described above. Examples include receptors cloned by Neote et al. (1993) Cell 72, 415; Kouba et al. FEBS Lett. (1993)321, 173; and Birkenbach et al. (1993) J. Virol. 67, 2209.

Known ligands for G protein coupled receptors include: purines and nucleotides, such as adenosine, cAMP, ATP, UTP, ADP, melatonin and the like; biogenic amines (and related natural ligands), such as 5-hydroxytryptamine, acetylcholine, dopamine, adrenaline, histamine, noradrenaline, tyramine/octopamine and other related compounds; peptides such as adrenocorticotrophic hormone (acth), melanocyte stimulating hormone (msh), melanocortins, neurotensin (nt), bombesin and related peptides, endothelins, cholecystokinin, gastrin, neurokinin b (nk3), invertebrate tachykinin-like peptides, substance k (nk2), substance p (nk1), neuropeptide y (npy), thyrotropin releasing-factor (trf), bradykinin, angiotensin ii, beta-endorphin, c5a anaphalatoxin, calcitonin, chemokines (also called intercrines), corticotrophic releasing factor (crf), dynorphin, endorphin, fmlp and other formylated peptides, follitropin (fsh), fungal mating pheromones, galanin, gastric inhibitory polypeptide receptor (gip), glucagon-like peptides (glps), glucagon, gonadotropin releasing hormone (gnrh), growth hormone releasing hormone (ghrh), insect diuretic hormone, interleukin-8, leutropin (1 h/hcg), met-enkephalin, opioid peptides, oxytocin, parathyroid hormone (pth) and pthrp, pituitary adenylyl cyclase activating peptide (pacap), secretin, somatostatin, thrombin, thyrotropin (tsh), vasoactive intestinal peptide (vip), vasopressin, vasotocin; eicosanoids such as ip-prostacyclin, pg-prostaglandins, tx-thromboxanes; retinal based compounds such as vertebrate 11-cis retinal, invertebrate 11-cis retinal and other related compounds; lipids and lipid-based compounds such as cannabinoids, anandamide, lysophosphatidic acid, platelet activating factor, leukotrienes and the like; excitatory amino acids and ions such as calcium ions and glutamate.

Preferred G protein coupled receptors include, but are not limited to: α1-adrenergic receptor, α1B-adrenergic receptor, α2-adrenergic receptor, α2B-adrenergic receptor, β1-adrenergic receptor, β2-adrenergic receptor, β3-adrenergic receptor, m1 acetylcholine receptor (AChR), m2 AChR, m3 AChR, m4 AChR, m5 AChR, D1 dopamine receptor, D2 dopamine receptor, D3 dopamine receptor, D4 dopamine receptor, D5 dopamine receptor, A1 adenosine receptor, A2a adenosine receptor, A2b adenosine receptor, A3 adenosine receptor, 5-HT1a receptor, 5-HT1b receptor, 5HT1-like receptor, 5-HT1d receptor, 5HT1d-like receptor, 5HT1d beta receptor, substance K (neurokinin A) receptor, fMLP receptor (FPR), fMLP-like receptor (FPRL-1), angiotensin II type 1 receptor, endothelin ETA receptor, endothelin ETB receptor, thrombin receptor, growth hormone-releasing hormone (GHRH) receptor, vasoactive intestinal peptide receptor, oxytocin receptor, somatostatin SSTR1 and SSTR2, SSTR3, cannabinoid receptor, follicle stimulating hormone (FSH) receptor, leutropin (LH/HCG) receptor, thyroid stimulating hormone (TSH) receptor, thromboxane A2 receptor, platelet-activating factor (PAF) receptor, C5a anaphylatoxin receptor, CXCR1 (IL-8 receptor A), CXCR2 (IL-8 receptor B), Delta Opioid receptor, Kappa Opioid receptor, mip-1alpha/RANTES receptor (CRR1), Rhodopsin, Red opsin, Green opsin, Blue opsin, metabotropic glutamate mGluR1-6, histamine H2 receptor, ATP receptor, neuropeptide Y receptor, amyloid protein precursor receptor, insulin-like growth factor II receptor, bradykinin receptor, gonadotropin-releasing hormone receptor, cholecystokinin receptor, melanocyte stimulating hormone receptor, antidiuretic hormone receptor, glucagon receptor, and adrenocorticotropic hormone II receptor. In addition, there are at least five receptors (CC and CXC receptors) involved in HIV viral attachment to cells. The two major co-receptors for HIV are CXCR4, (fusin receptor, LESTR, SDF-1α receptor) and CCR5 (m-trophic). More preferred receptors include the following human receptors: melatonin receptor 1a, galanin receptor 1, neurotensin receptor, adenosine receptor 2a, somatostatin receptor 2 and corticotropin releasing factor receptor 1. Melatonin receptor 1a is particularly preferred. Other G protein coupled receptors (GPCRs) are known in the art.

In one embodiment, Lnk is a protein to be measured. Hematopoietic stem cells (HSCs) give rise to variety of hematopoietic cells via pluripotential progenitors. Lineage-committed progenitors are responsible for blood production throughout adult life. Amplification of HSCs or progenitors represents a potentially powerful approach to the treatment of various blood disorders. Animal model studies demonstrated that Lnk acts as a broad inhibitor of signaling pathways in hematopoietic lineages. Lnk is an adaptor protein which belongs to a family of proteins sharing several structural motifs, including a Src homology 2 (SH2) domain which binds phospho-tyrosines in various signal-transducing proteins. The SH2 domain is essential for Lnk-mediated negative regulation of several cytokine receptors (i.e. Mp1, EpoR, c-Kit, II-3R and IL7R). Therefore, inhibition of the binding of Lnk to cytokine receptors might lead to enhanced downstream signaling of the receptor and thereby to improved hematopoiesis in response to exposure to cytokines (i.e. erythropoietin in anemic patients). (Gueller et al, Adaptor protein Lnk associates with Y568 in c-Kit. 1: Biochem J. 2008 Jun. 30.) It has been shown that overexpression of Lnk in Ba/F3-MPLW515L cells inhibits cytokine-independent growth, while suppression of Lnk in UT7-MPLW515L cells enhances proliferation. Lnk blocks the activation of Jak2, Stat3, Erk, and Akt in these cells. (Gery et al., Adaptor protein Lnk negatively regulates the mutant MPL, MPLW515L associated with myeloproliferative neoplasms, Blood, 1 November 2007, Vol. 110, No. 9, pp. 3360-3364.)

In one embodiment, the activatable elements are intracellular receptors capable of clustering. Elements of this class are not membrane-bound. Instead, they are free to diffuse through the intracellular matrix where they bind soluble ligands prior to clustering and signal transduction. In contrast to the previously described elements, many members of this class are capable of binding DNA after clustering to directly effect changes in RNA transcription.

In another embodiment the intracellular receptors capable of clustering are perioxisome proliferator-activated receptors (PPAR). PPARs are soluble receptors responsive to lipophillic compounds, and induce various genes involved in fatty acid metabolism. The three PPAR subtypes, PPAR α, β, and γ have been shown to bind to DNA after ligand binding and heterodimerization with retinoid X receptor. (Summanasekera, et al., J Biol Chem, M211261200, Dec. 13, 2002.)

In another embodiment the activatable element is a nucleic acid. Activation and deactivation of nucleic acids can occur in numerous ways including, but not limited to, cleavage of an inactivating leader sequence as well as covalent or non-covalent modifications that induce structural or functional changes. For example, many catalytic RNAs, e.g. hammerhead ribozymes, can be designed to have an inactivating leader sequence that deactivates the catalytic activity of the ribozyme until cleavage occurs. An example of a covalent modification is methylation of DNA. Deactivation by methylation has been shown to be a factor in the silencing of certain genes, e.g. STAT regulating SOCS genes in lymphomas. See Leukemia. See February 2004; 18(2): 356-8. SOCS1 and SHPT hypermethylation in mantle cell lymphoma and follicular lymphoma: implications for epigenetic activation of the Jak/STAT pathway. Chim C S, Wong K Y, Loong F, Srivastava G.

In another embodiment the activatable element is a small molecule, carbohydrate, lipid or other naturally occurring or synthetic compound capable of having an activated isoform. In addition, as pointed out above, activation of these elements need not include switching from one form to another, but can be detected as the presence or absence of the compound. For example, activation of cAMP (cyclic adenosine mono-phosphate) can be detected as the presence of cAMP rather than the conversion from non-cyclic AMP to cyclic AMP.

Examples of proteins that may include activatable elements include, but are not limited to kinases, phosphatases, lipid signaling molecules, adaptor/scaffold proteins, cytokines, cytokine regulators, ubiquitination enzymes, adhesion molecules, cytoskeletal/contractile proteins, heterotrimeric G proteins, small molecular weight GTPases, guanine nucleotide exchange factors, GTPase activating proteins, caspases, proteins involved in apoptosis, cell cycle regulators, molecular chaperones, metabolic enzymes, vesicular transport proteins, hydroxylases, isomerases, deacetylases, methylases, demethylases, tumor suppressor genes, proteases, ion channels, molecular transporters, transcription factors/DNA binding factors, regulators of transcription, and regulators of translation. Examples of activatable elements, activation states and methods of determining the activation level of activatable elements are described in US Publication Number 20060073474 entitled “Methods and compositions for detecting the activation state of multiple proteins in single cells” and US Publication Number 20050112700 entitled “Methods and compositions for risk stratification” the content of which are incorporate here by reference. See also U.S. Ser. Nos. 61/048,886; 61/048,920; and Shulz al., Current Protocols in Immunology 2007, 78:8.17.1-20.

In some embodiments, the protein is selected from the group consisting of HER receptors, PDGF receptors, Kit receptor, FGF receptors, Eph receptors, Trk receptors, IGF receptors, Insulin receptor, Met receptor, Ret, VEGF receptors, TIE1, TIE2, FAK, Jak1, Jak2, Jak3, Tyk2, Src, Lyn, Fyn, Lck, Fgr, Yes, Csk, Abl, Btk, ZAP70, Syk, IRAKs, cRaf, ARaf, BRAF, Mos, Lim kinase, ILK, Tpl, ALK, TGFβ receptors, BMP receptors, MEKKs, ASK, MLKs, DLK, PAKs, Mek 1, Mek 2, MKK3/6, MKK4/7, ASK1, Cot, NIK, Bub, Myt 1, Wee1, Casein kinases, PDK1, SGK1, SGK2, SGK3, Akt1, Akt2, Akt3, p90Rsks, p70S6 Kinase, Prks, PKCs, PKAs, ROCK 1, ROCK 2, Auroras, CaMKs, MNKs, AMPKs, MELK, MARKs, Chk1, Chk2, LKB-1, MAPKAPKs, Pim1, Pim2, Pim3, IKKs, Cdks, Jnks, Erks, IKKs, GSK3α, GSK3β, Cdks, CLKs, PKR, PI3-Kinase class 1, class 2, class 3, mTor, SAPK/JNK1,2,3, p38s, PKR, DNA-PK, ATM, ATR, Receptor protein tyrosine phosphatases (RPTPs), LAR phosphatase, CD45, Non receptor tyrosine phosphatases (NPRTPs), SHPs, MAP kinase phosphatases (MKPs), Dual Specificity phosphatases (DUSPs), CDC25 phosphatases, Low molecular weight tyrosine phosphatase, Eyes absent (EYA) tyrosine phosphatases, Slingshot phosphatases (SSH), serine phosphatases, PP2A, PP2B, PP2C, PP1, PP5, inositol phosphatases, PTEN, SHIPs, myotubularins, phosphoinositide kinases, phopsholipases, prostaglandin synthases, 5-lipoxygenase, sphingosine kinases, sphingomyelinases, adaptor/scaffold proteins, Shc, Grb2, BLNK, LAT, B cell adaptor for PI3-kinase (BCAP), SLAP, Dok, KSR, MyD88, Crk, CrkL, GAD, Nck, Grb2 associated binder (GAB), Fas associated death domain (FADD), TRADD, TRAF2, RIP, T-Cell leukemia family, IL-2, IL-4, IL-8, IL-6, interferon γ, interferon α, suppressors of cytokine signaling (SOCs), Cbl, SCF ubiquitination ligase complex, APC/C, adhesion molecules, integrins, Immunoglobulin-like adhesion molecules, selectins, cadherins, catenins, focal adhesion kinase, p130CAS, fodrin, actin, paxillin, myosin, myosin binding proteins, tubulin, eg5/KSP, CENPs, β-adrenergic receptors, muscarinic receptors, adenylyl cyclase receptors, small molecular weight GTPases, H-Ras, K-Ras, N-Ras, Ran, Rac, Rho, Cdc42, Arfs, RABs, RHEB, Vav, Tiam, Sos, Dbl, PRK, TSC1,2, Ras-GAP, Arf-GAPs, Rho-GAPs, caspases, Caspase 2, Caspase 3, Caspase 6, Caspase 7, Caspase 8, Caspase 9, Bcl-2, Mcl-1, Bcl-XL, Bcl-w, Bcl-B, A1, Bax, Bak, Bok, Bik, Bad, Bid, Bim, Bmf, Hrk, Noxa, Puma, IAPs, XIAP, Smac, Cdk4, Cdk 6, Cdk 2, Cdk1, Cdk 7, Cyclin D, Cyclin E, Cyclin A, Cyclin B, Rb, p16, p14Arf, p27KIP, p21CIP, molecular chaperones, Hsp90s, Hsp70, Hsp27, metabolic enzymes, Acetyl-CoA Carboxylase, ATP citrate lyase, nitric oxide synthase, caveolins, endosomal sorting complex required for transport (ESCRT) proteins, vesicular protein sorting (Vsps), hydroxylases, prolyl-hydroxylases PHD-1, 2 and 3, asparagine hydroxylase FIH transferases, Pin1 prolyl isomerase, topoisomerases, deacetylases, Histone deacetylases, sirtuins, histone acetylases, CBP/P300 family, MYST family, ATF2, DNA methyl transferases, Histone H3K4 demethylases, H3K27, JHDM2A, UTX, VHL, WT-1, p53, Hdm, PTEN, ubiquitin proteases, urokinase-type plasminogen activator (uPA) and uPA receptor (uPAR) system, cathepsins, metalloproteinases, esterases, hydrolases, separase, potassium channels, sodium channels, multi-drug resistance proteins, P-Gycoprotein, nucleoside transporters, Ets, Elk, SMADs, Rel-A (p65-NFKB), CREB, NFAT, ATF-2, AFT, Myc, Fos, Spl, Egr-1, T-bet, β-catenin, HIFs, FOXOs, E2Fs, SRFs, TCFs, Egr-1, β-catenin, FOXO STAT1, STAT 3, STAT 4, STAT 5, STAT 6, p53, WT-1, HMGA, pS6, 4EPB-1, eIF4E-binding protein, RNA polymerase, initiation factors, elongation factors.

In some embodiments of the invention, the methods described herein are employed to determine the activation level of an activatable element, e.g., in a cellular pathway. Methods and compositions are provided for the classification of a cell according to the activation level of an activatable element in a cellular pathway. The cell can be a hematopoietic cell. Examples of hematopoietic cells include but are not limited to pluripotent hematopoietic stem cells, granulocyte lineage progenitor or derived cells, monocyte lineage progenitor or derived cells, macrophage lineage progenitor or derived cells, megakaryocyte lineage progenitor or derived cells and erythroid lineage progenitor or derived cells.

### Signaling Pathways

In some embodiments, the methods of the invention are employed to determine the activation level of an activatable element in a signaling pathway. In some embodiments, the biological state of a cell is determined, as described herein, according to the activation level of one or more activatable elements in one or more signaling pathways. Signaling pathways and their members have been extensively described. See (Hunter T. Cell Jan. 7, 2000; 100(1): 13-27; Weinberg, 2007; and Blume-Jensen and Hunter, Nature, vol 411, 17 May 2001, p 355-365 cited above). See also the patent applications incorporated above for discussions of pathways.

Exemplary signaling pathways include the following pathways and their members: the JAK-STAT pathway including JAKs, STATs 2, 3 4 and 5, the FLT3L signaling pathway, the MAP kinase pathway including Ras, Raf, MEK, ERK and elk; the PI3K/Akt pathway including PI-3-kinase, PDK1, Akt and Bad; the NF-KB pathway including IKKs, IkB and NF-κB and the Wnt pathway including frizzled receptors, beta-catenin, APC and other co-factors and TCF (see Cell Signaling Technology, Inc. 2002 Catalog pages 231-279 and Hunter T., supra.). In some embodiments of the invention, the correlated activatable elements being assayed (or the signaling proteins being examined) are members of the MAP kinase, Akt, NFkB, WNT, STAT and/or PKC signaling pathways.

In some embodiments, the methods of the invention are employed to determine the activation level of a signaling protein in a signaling pathway known in the art including those described herein. Exemplary types of signaling proteins within the scope of the present invention include, but are not limited to, kinases, kinase substrates (i.e. phosphorylated substrates), phosphatases, phosphatase substrates, binding proteins (such as 14-3-3), receptor ligands and receptors (cell surface receptor tyrosine kinases and nuclear receptors)). Kinases and protein binding domains, for example, have been well described (see, e.g., Cell Signaling Technology, Inc., 2002 Catalogue “The Human Protein Kinases” and “Protein Interaction Domains” pgs. 254-279).

Exemplary signaling proteins include, but are not limited to, kinases, HER receptors, PDGF receptors, Kit receptor, FGF receptors, Eph receptors, Trk receptors, IGF receptors, Insulin receptor, Met receptor, Ret, VEGF receptors, TIE1, TIE2, FAK, Jak1, Jak2, Jak3, Tyk2, Src, Lyn, Fyn, Lck, Fgr, Yes, Csk, Abl, Btk, ZAP70, Syk, IRAKs, cRaf, ARaf, BRAF, Mos, Lim kinase, ILK, Tpl, ALK, TGFβ receptors, BMP receptors, MEKKs, ASK, MLKs, DLK, PAKs, Mek 1, Mek 2, MKK3/6, MKK4/7, ASK1, Cot, NIK, Bub, Myt 1, Wee1, Casein kinases, PDK1, SGK1, SGK2, SGK3, Akt1, Akt2, Akt3, p90Rsks, p70S6Kinase, Prks, PKCs, PKAs, ROCK 1, ROCK 2, Auroras, CaMKs, MNKs, AMPKs, MELK, MARKs, Chk1, Chk2, LKB-1, MAPKAPKs, Pim1, Pim2, Pim3, IKKs, Cdks, Jnks, Erks, IKKs, GSK3α, GSK3β, Cdks, CLKs, PKR, PI3-Kinase class 1, class 2, class 3, mTor, SAPK/JNK1,2,3, p38s, PKR, DNA-PK, ATM, ATR, phosphatases, Receptor protein tyrosine phosphatases (RPTPs), LAR phosphatase, CD45, Non receptor tyrosine phosphatases (NPRTPs), SHPs, MAP kinase phosphatases (MKPs), Dual Specificity phosphatases (DUSPs), CDC25 phosphatases, low molecular weight tyrosine phosphatase, Eyes absent (EYA) tyrosine phosphatases, Slingshot phosphatases (SSH), serine phosphatases, PP2A, PP2B, PP2C, PP1, PP5, inositol phosphatases, PTEN, SHIPs, myotubularins, lipid signaling, phosphoinositide kinases, phopsholipases, prostaglandin synthases, 5-lipoxygenase, sphingosine kinases, sphingomyelinases, adaptor/scaffold proteins, Shc, Grb2, BLNK, LAT, B cell adaptor for PI3-kinase (BCAP), SLAP, Dok, KSR, MyD88, Crk, CrkL, GAD, Nck, Grb2 associated binder (GAB), Fas associated death domain (FADD), TRADD, TRAF2, RIP, T-Cell leukemia family, cytokines, IL-2, IL-4, IL-8, IL-6, interferon γ, interferon α, cytokine regulators, suppressors of cytokine signaling (SOCs), ubiquitination enzymes, Cbl, SCF ubiquitination ligase complex, APC/C, adhesion molecules, integrins, Immunoglobulin-like adhesion molecules, selectins, cadherins, catenins, focal adhesion kinase, p130CAS, cytoskeletal/contractile proteins, fodrin, actin, paxillin, myosin, myosin binding proteins, tubulin, eg5/KSP, CENPs, heterotrimeric G proteins, β-adrenergic receptors, muscarinic receptors, adenylyl cyclase receptors, small molecular weight GTPases, H-Ras, K-Ras, N-Ras, Ran, Rac, Rho, Cdc42, Arfs, RABs, RHEB, guanine nucleotide exchange factors, Vav, Tiam, Sos, Dbl, PRK, TSC1,2, GTPase activating proteins, Ras-GAP, Arf-GAPs, Rho-GAPs, caspases, Caspase 2, Caspase 3, Caspase 6, Caspase 7, Caspase 8, Caspase 9, proteins involved in apoptosis, Bcl-2, Mcl-1, Bcl-XL, Bcl-w, Bcl-B, A1, Bax, Bak, Bok, Bik, Bad, Bid, Bim, Bmf, Hrk, Noxa, Puma, IAPB, XIAP, Smac, cell cycle regulators, Cdk4, Cdk 6, Cdk 2, Cdk1, Cdk 7, Cyclin D, Cyclin E, Cyclin A, Cyclin B, Rb, p16, pl4Arf, p27KIP, p21CIP, molecular chaperones, Hsp90s, Hsp70, Hsp27, metabolic enzymes, Acetyl-CoAa Carboxylase, ATP citrate lyase, nitric oxide synthase, vesicular transport proteins, caveolins, endosomal sorting complex required for transport (ESCRT) proteins, vesicular protein sorting (Vsps), hydroxylases, prolyl-hydroxylases PHD-1, 2 and 3, asparagine hydroxylase FIH transferases, isomerases, Pin1 prolyl isomerase, topoisomerases, deacetylases, Histone deacetylases, sirtuins, acetylases, histone acetylases, CBP/P300 family, MYST family, ATF2, methylases, DNA methyl transferases, demethylases, Histone H3K4 demethylases, H3K27, JHDM2A, UTX, tumor suppressor genes, VHL, WT-1, p53, Hdm, PTEN, proteases, ubiquitin proteases, urokinase-type plasminogen activator (uPA) and uPA receptor (uPAR) system, cathepsins, metalloproteinases, esterases, hydrolases, separase, ion channels, potassium channels, sodium channels, molecular transporters, multi-drug resistance proteins, P-Gycoprotein, nucleoside transporters, transcription factors/DNA binding proteins, Ets, Elk, SMADs, Rel-A (p65-NFKB), CREB, NFAT, ATF-2, AFT, Myc, Fos, Spl, Egr-1, T-bet, β-catenin, HIFs, FOXOs, E2Fs, SRFs, TCFs, Egr-1, β-catenin, FOXO STAT1, STAT 3, STAT 4, STAT 5, STAT 6, p53, WT-1, HMGA, regulators of translation, pS6, 4EPB-1, eIF4E-binding protein, regulators of transcription, RNA polymerase, initiation factors, and elongation factors.

In some embodiments the protein is selected from the group consisting of PI3-Kinase (p85, p110a, p110b, p110d), Jak1, Jak2, SOCs, Rac, Rho, Cdc42, Ras-GAP, Vav, Tiam, Sos, Dbl, Nck, Gab, PRK, SHP1, and SHP2, SHIP1, SHIP2, sSHIP, PTEN, Shc, Grb2, PDK1, SGK, Akt1, Akt2, Akt3, TSC1,2, Rheb, mTor, 4EBP-1, p70S6Kinase, S6, LKB-1, AMPK, PFK, Acetyl-CoAa Carboxylase, DokS, Rafs, Mos, Tp12, MEK1/2, MLK3, TAK, DLK, MKK3/6, MEKK1,4, MLK3, ASK1, MKK4/7, SAPK/JNK1,2,3, p38s, Erk1/2, Syk, Btk, BLNK, LAT, ZAP70, Lck, Cbl, SLP-76, PLCyi, PLCy 2, STAT1, STAT 3, STAT 4, STAT 5, STAT 6, FAK, p130CAS, PAKs, LIMK1/2, Hsp90, Hsp70, Hsp27, SMADs, Rel-A (p65-NFKB), CREB, Histone H2B, HATs, HDACs, PKR, Rb, Cyclin D, Cyclin E, Cyclin A, Cyclin B, P16, pl4Arf, p27KIP, p21CIP, Cdk4, Cdk6, Cdk7, Cdk1, Cdk2, Cdk9, Cdc25, A/B/C, Abl, E2F, FADD, TRADD, TRAF2, RIP, Myd88, BAD, Bcl-2, Mcl-1, Bcl-XL, Caspase 2, Caspase 3, Caspase 6, Caspase 7, Caspase 8, Caspase 9, IAPB, Smac, Fodrin, Actin, Src, Lyn, Fyn, Lck, NIK, IκB, p65(RelA), IKKα, PKA, PKCα, PKC β, PKCθ, PKCδ, CAMK, Elk, AFT, Myc, Egr-1, NFAT, ATF-2, Mdm2, p53, DNA-PK, Chk1, Chk2, ATM, ATR, βcatenin, CrkL, GSK3α, GSK3β, and FOXO.

### Generating of Activation State Data

One or more cells or cell types, or samples containing one or more cells or cell types, can be isolated from body samples. The cells can be separated from body samples by centrifugation, elutriation, density gradient separation, apheresis, affinity selection, panning, FACS, centrifugation with Hypaque, solid supports (magnetic beads, beads in columns, or other surfaces) with attached antibodies, etc. By using antibodies specific for markers identified with particular cell types, a relatively homogeneous population of cells may be obtained. Cells can also be separated by using filters. For example, whole blood can also be applied to filters that are engineered to contain pore sizes that select for the desired cell type or class. Rare pathogenic cells can be filtered out of diluted, whole blood following the lysis of red blood cells by using filters with pore sizes between 5 to 10 μm, as disclosed in U.S. patent application Ser. No. 09/790,673. Alternatively, a heterogeneous cell population may be analyzed. Alternatively, a whole sample, without any cell separation may be used, e.g. whole blood (See U.S. Ser. No. 61/226,878, example 4). Once a sample is obtained, it can be used directly, frozen, or maintained in appropriate culture medium for short periods of time. Methods to isolate one or more cells for use according to the methods of this invention are performed according to standard techniques and protocols well-established in the art. See also U.S. Ser. Nos. 61/048,886; 61/048,920; and 61/048,657. See also, the commercial products from companies such as BD and BCI as identified above.

See also U.S. Pat. Nos. 7,381,535 and 7,393,656. All of the above patents and applications are incorporated by reference as stated above.

In some embodiments, the cells are cultured post collection in a media suitable for revealing the activation level of an activatable element (e.g. RPMI, DMEM) in the presence, or absence, of serum such as fetal bovine serum, bovine serum, human serum, porcine serum, horse serum, or goat serum. When serum is present in the media it could be present at a level ranging from 0.0001% to 30%.

Examples of hematopoietic cells include but are not limited to pluripotent hematopoietic stem cells, B-lymphocyte lineage progenitor or derived cells, T-lymphocyte lineage progenitor or derived cells, NK cell lineage progenitor or derived cells, granulocyte lineage progenitor or derived cells, monocyte lineage progenitor or derived cells, megakaryocyte lineage progenitor or derived cells and erythroid lineage progenitor or derived cells.

In practicing the methods of this invention, the detection of the status of the one or more activatable elements can be carried out by a person, such as a technician in the central laboratory. Alternatively, the detection of the status of the one or more activatable elements can be carried out using automated systems. In either case, the detection of the status of the one or more activatable elements for use according to the methods of this invention is performed according to standard techniques and protocols well-established in the art.

One or more activatable elements can be detected and/or quantified by any method that detect and/or quantitates the presence of the activatable element of interest. Such methods may include radioimmunoassay (RIA) or enzyme linked immunoabsorbance assay (ELISA), immunohistochemistry, immunofluorescent histochemistry with or without confocal microscopy, reversed phase assays, homogeneous enzyme immunoassays, and related non-enzymatic techniques, Western blots, whole cell staining, immunoelectronmicroscopy, nucleic acid amplification, gene array, protein array, mass spectrometry, patch clamp, 2-dimensional gel electrophoresis, differential display gel electrophoresis, microsphere-based multiplex protein assays, label-free cellular assays and flow cytometry, etc. U.S. Pat. No. 4,568,649 describes ligand detection systems, which employ scintillation counting. These techniques are particularly useful for modified protein parameters. Cell readouts for proteins and other cell determinants can be obtained using fluorescent or otherwise tagged reporter molecules. Flow cytometry methods are useful for measuring intracellular parameters.

In some embodiments, the present invention provides methods for determining an activatable element's activation profile for a single cell. The methods may comprise analyzing cells by flow cytometry on the basis of the activation level of at least two activatable elements. Binding elements (e.g. activation state-specific antibodies) are used to analyze cells on the basis of activatable element activation level, and can be detected as described below. Alternatively, non-binding elements systems as described above can be used in any system described herein. One embodiment uses single cell network profiling (SCNP).

Detection of cell signaling states may be accomplished using binding elements and labels. Cell signaling states may be detected by a variety of methods known in the art. They generally involve a binding element, such as an antibody, and a label, such as a fluorochrome to form a detection element. Detection elements do not need to have both of the above agents, but can be one unit that possesses both qualities. These and other methods are well described in U.S. Pat. Nos. 7,381,535 and 7,393,656 and U.S. Ser. Nos. 10/193,462; 11/655,785; 11/655,789; 11/655,821; 11/338,957, 61/048,886; 61/048,920; and 61/048,657 which are all incorporated by reference in their entireties.

In one embodiment of the invention, it is advantageous to increase the signal to noise ratio by contacting the cells with the antibody and label for a time greater than 5, 6, 7, 8, 9, 10, 11, 12, 13, 14, 15, 16, 17, 18, 19, 20, 24 or up to 48 or more hours.

When using fluorescent labeled components in the methods and compositions of the present invention, it will recognized that different types of fluorescent monitoring systems, e.g., Cytometric measurement device systems, can be used to practice the invention. In some embodiments, flow cytometric systems are used or systems dedicated to high throughput screening, e.g. 96 well or greater microtiter plates. Methods of performing assays on fluorescent materials are well known in the art and are described in, e.g., Lakowicz, J. R., Principles of Fluorescence Spectroscopy, New York: Plenum Press (1983); Herman, B., Resonance energy transfer microscopy, in: Fluorescence Microscopy of Living Cells in Culture, Part B, Methods in Cell Biology, vol. 30, ed. Taylor, D. L. & Wang, Y.-L., San Diego: Academic or government Press (1989), pp. 219-243; Turro, N.J., Modern Molecular Photochemistry, Menlo Park: Benjamin/Cummings Publishing Col, Inc. (1978), pp. 296-361.

Fluorescence in a sample can be measured using a fluorimeter. In general, excitation radiation, from an excitation source having a first wavelength, passes through excitation optics. The excitation optics cause the excitation radiation to excite the sample. In response, fluorescent proteins in the sample emit radiation that has a wavelength that is different from the excitation wavelength. Collection optics then collect the emission from the sample. The device can include a temperature controller to maintain the sample at a specific temperature while it is being scanned. According to one embodiment, a multi-axis translation stage moves a microtiter plate holding a plurality of samples in order to position different wells to be exposed. The multi-axis translation stage, temperature controller, auto-focusing feature, and electronics associated with imaging and data collection can be managed by an appropriately programmed digital computer. The computer also can transform the data collected during the assay into another format for presentation. In general, known robotic systems and components can be used.

Other methods of detecting fluorescence may also be used, e.g., Quantum dot methods (see, e.g., Goldman et al., J. Am. Chem. Soc. (2002) 124:6378-82; Pathak et al. J. Am. Chem. Soc. (2001) 123:4103-4; and Remade et al., Proc. Natl. Sci. USA (2000) 18:553-8, each expressly incorporated herein by reference) as well as confocal microscopy. In general, flow cytometry involves the passage of individual cells through the path of a laser beam. The scattering the beam and excitation of any fluorescent molecules attached to, or found within, the cell is detected by photomultiplier tubes to create a readable output, e.g. size, granularity, or fluorescent intensity.

The detecting, sorting, or isolating step of the methods of the present invention can entail fluorescence-activated cell sorting (FACS) techniques, where FACS is used to select cells from the population containing a particular surface marker, or the selection step can entail the use of magnetically responsive particles as retrievable supports for target cell capture and/or background removal. A variety of FACS systems are known in the art and can be used in the methods of the invention (see e.g., WO99/54494, filed Apr. 16, 1999; U.S. Ser. No. 20010006787, filed Jul. 5, 2001, each expressly incorporated herein by reference).

In some embodiments, a FACS cell sorter (e.g. a FACSVantage™ Cell Sorter, Becton Dickinson Immunocytometry Systems, San Jose, Calif.) is used to sort and collect cells based on their activation profile (positive cells) in the presence or absence of an increase in activation level in an activatable element in response to a modulator. Other flow cytometers that are commercially available include the LSR II and the Canto II both available from Becton Dickinson. See Shapiro, Howard M., Practical Flow Cytometry, 4th Ed., John Wiley & Sons, Inc., 2003 for additional information on flow cytometers.

In some embodiments, the cells are first contacted with fluorescent-labeled activation state-specific binding elements (e.g. antibodies) directed against specific activation state of specific activatable elements. In such an embodiment, the amount of bound binding element on each cell can be measured by passing droplets containing the cells through the cell sorter. By imparting an electromagnetic charge to droplets containing the positive cells, the cells can be separated from other cells. The positively selected cells can then be harvested in sterile collection vessels. These cell-sorting procedures are described in detail, for example, in the FACSVantage™. Training Manual, with particular reference to sections 3-11 to 3-28 and 10-1 to 10-17, which is hereby incorporated by reference in its entirety. See the patents, applications and articles referred to, and incorporated above for detection systems.

Fluorescent compounds such as Daunorubicin and Enzastaurin are problematic for flow cytometry based biological assays due to their broad fluorescence emission spectra. These compounds get trapped inside cells after fixation with agents like paraformaldehyde, and are excited by one or more of the lasers found on flow cytometers. The fluorescence emission of these compounds is often detected in multiple PMT detectors which complicates their use in multiparametric flow cytometry. A way to get around this problem is to compensate out the fluorescence emission of the compound from the PMT detectors used to measure the relevant biological markers. This is achieved using a PMT detector with a bandpass filter near the emission maximum of the fluorescent compound, and cells incubated with the compound as the compensation control when calculating a compensation matrix. The cells incubated with the fluorescent compound are fixed with paraformaldehyde, then washed and permeabilized (“permed”) with 100% methanol. The methanol is washed out and the cells are mixed with unlabeled fixed/permed cells to yield a compensation control consisting of a mixture of fluorescent and negative cell populations.

In another embodiment, positive cells can be sorted using magnetic separation of cells based on the presence of an isoform of an activatable element. In such separation techniques, cells to be positively selected are first contacted with specific binding element (e.g., an antibody or reagent that binds an isoform of an activatable element). The cells are then contacted with retrievable particles (e.g., magnetically responsive particles) that are coupled with a reagent that binds the specific element. The cell-binding element-particle complex can then be physically separated from non-positive or non-labeled cells, for example, using a magnetic field. When using magnetically responsive particles, the positive or labeled cells can be retained in a container using a magnetic field while the negative cells are removed. These and similar separation procedures are described, for example, in the Baxter Immunotherapy Isolex training manual which is hereby incorporated in its entirety.

In some embodiments, methods for the determination of a receptor element activation state profile for a single cell are provided. The methods comprise providing a population of cells and analyze the population of cells by flow cytometry. Preferably, cells are analyzed on the basis of the activation level of at least two activatable elements. In some embodiments, a multiplicity of activatable element activation-state antibodies is used to simultaneously determine the activation level of a multiplicity of elements.

Flow cytometry is useful in a clinical setting, since relatively small sample sizes, as few as 10,000 cells, can produce a considerable amount of statistically tractable multidimensional signaling data and reveal key cell subsets that are responsible for a phenotype. See U.S. Pat. Nos. 7,381,535 and 7,393,656. See also Krutzik et al, 2004. Other methods for analyzing single cells include mass spec and laser cytometry.

In some embodiment, cell analysis by flow cytometry on the basis of the activation level of at least two elements is combined with a determination of other flow cytometry readable outputs, such as the presence of surface markers, granularity and cell size to provide a correlation between the activation level of a multiplicity of elements and other cell qualities measurable by flow cytometry for single cells.

When necessary cells are dispersed into a single cell suspension, e.g. by enzymatic digestion with a suitable protease, e.g. collagenase, dispase, etc; and the like. An appropriate solution is used for dispersion or suspension. Such solution will generally be a balanced salt solution, e.g. normal saline, PBS, Hanks balanced salt solution, etc., conveniently supplemented with fetal calf serum or other naturally occurring factors, in conjunction with an acceptable buffer at low concentration, generally from 5-25 mM. Convenient buffers include HEPES1 phosphate buffers, lactate buffers, etc. The cells may be fixed, e.g. with 3% paraformaldehyde, and are usually permeabilized, e.g. with ice cold methanol; HEPES-buffered PBS containing 0.1% saponin, 3% BSA; covering for 2 min in acetone at −200C; and the like as known in the art and according to the methods described herein.

In some embodiments, one or more cells are contained in a well of a 96 well plate or other commercially available multiwell plate. In an alternate embodiment, the reaction mixture or cells are in a cytometric measurement device. Other multiwell plates useful in the present invention include, but are not limited to 384 well plates and 1536 well plates. Still other vessels for containing the reaction mixture or cells and useful in the present invention will be apparent to the skilled artisan.

The addition of the components of the assay for detecting the activation level or activity of an activatable element, or modulation of such activation level or activity, may be sequential or in a predetermined order or grouping under circumstances appropriate for the activity that is assayed for. Such circumstances are described here and known in the art.

In some embodiments, assessment of the activation state of the activatable element is made using mass spectrometry. The activation state of the activatable element can be determined using quantitative mass spectrometry. One type of quantitative mass spectrometry is stable isotope labeling by amino acids in cell culture (SILAC). To enable quantitative assessment of activation using SILAC, cells are grown in either light medium (e.g. containing the radio-neutral form of the natural amino acids lysine and arginine) or in heavy medium (e.g. containing lysine and arginine having naturally-occurring carbon-12 completely substituted with the carbon-13 isotope). SILAC methods are further described in U.S. Ser. Nos. 11/368,996 and 11/314,323, and U.S. Pat. Nos. 7,300,753 and 6,906,320. Following culture of cells for greater than 12, 14, 16, 18, 20, 22, 24, 30, 36, 48, or 72 hours, the appropriate carbon isotope is incorporated into cellular proteins from the growth medium. Cells cultured thus can be treated to isolate and query an activatable element using any of the methods described herein. For example, antibodies can be used to immunoprecipitate a target protein. Isolated proteins can be identified, quantified, and/or measured for one or more modifications using quantitative mass spectrometry. Pooling of samples obtained from heavy- and light-labeled cells can be used to detect heavy and light peptides simultaneously using mass spectrometry. This simultaneous detection allows direct quantitative comparison of heavy and light peptides. In some embodiments, one population of cells (e.g. heavy-labeled) is treated with a modulator, while the other population of cells (e.g. light-labeled) does not receive contact with the modulator. Cell populations that are differentially labeled and treated can be quantitatively compared using SILAC.

In some embodiments, no enrichment step is performed, and SILAC analysis is performed directly on whole cell lysates. To ensure that any measured changes are robust, SILAC procedures can be repeated with the labeling reversed

In some embodiments, the activation level of an activatable element is measured using Inductively Coupled Plasma Mass Spectrometer (ICP-MS). A binding element that has been labeled with a specific element binds to the activatable element. When the cell is introduced into the ICP, it is atomized and ionized. The elemental composition of the cell, including the labeled binding element that is bound to the activatable element, is measured. The presence and intensity of the signals corresponding to the labels on the binding element indicates the level of the activatable element on that cell (Tanner et al. Spectrochimica Acta Part B: Atomic Spectroscopy, 2007 March; 62(3):188-195.).

In some embodiments, assessment of the activation state of the activatable element is made using microfluidic image cytometry (MIC). Microscale technologies such as microfluidics offer intrinsic advantages of minimal sample/reagent usage, operational fidelity, high throughput, cost efficiency, and precise control over reagent and sample delivery to microscale environments. In some embodiments, microfluidic image cytometry involves a cell array chip comprising a plurality of microfluidic cell culture chambers, wherein each chamber has a volume of about 20, 30, 40, 50, 60, 70, 80, 90, 100, 120, 140, 160, 180, 200, 220, 240, 260, 280, 300, 350, 400, 450, or 500 mL. Microchannels can be etched on the chips using lithography methods known in the art in order to control contact of cells within the microfluidic cell culture chambers with various regeants and culture media.

Cells can be placed within the microfluidic cell culture chambers, and treated using microscale versions of the methods described herein. For example, the activation state of one or more activatable elements can be assessed for cells within the microfluidic cell culture chambers using immunocytochemistry. In other embodiments, the cells are analyzed using immunohistochemistry. Following the immunolabeling of these methods, the activation state of the activatable elements within the cells can be visualized using known microscopy-based image acquisition methods.

As will be appreciated by one of skill in the art, the instant methods and compositions find use in a variety of other assay formats in addition to flow cytometry analysis. For example, DNA microarrays are commercially available through a variety of sources (Affymetrix, Santa Clara, Calif.) or they can be custom made in the lab using arrayers which are also known (Perkin Elmer). In addition, protein chips and methods for synthesis are known. These methods and materials may be adapted for the purpose of affixing activation state binding elements to a chip in a prefigured array. In some embodiments, such a chip comprises a multiplicity of element activation state binding elements, and is used to determine an element activation state profile for elements present on the surface of a cell.

In some embodiments, a chip comprises a multiplicity of the “second set binding elements,” in this case generally unlabeled. Such a chip is contacted with sample, preferably cell extract, and a second multiplicity of binding elements comprising element activation state specific binding elements is used in the sandwich assay to simultaneously determine the presence of a multiplicity of activated elements in sample. Preferably, each of the multiplicity of activation state-specific binding elements is uniquely labeled to facilitate detection.

In some embodiments confocal microscopy can be used to detect activation profiles for individual cells. Confocal microscopy relies on the serial collection of light from spatially filtered individual specimen points, which is then electronically processed to render a magnified image of the specimen. The signal processing involved confocal microscopy has the additional capability of detecting labeled binding elements within single cells, accordingly in this embodiment the cells can be labeled with one or more binding elements. In some embodiments the binding elements used in connection with confocal microscopy are antibodies conjugated to fluorescent labels, however other binding elements, such as other proteins or nucleic acids are also possible.

In some embodiments, the methods and compositions of the instant invention can be used in conjunction with an “In-Cell Western Assay.” In such an assay, cells are initially grown in standard tissue culture flasks using standard tissue culture techniques. Once grown to optimum confluency, the growth media is removed and cells are washed and trypsinized. The cells can then be counted and volumes sufficient to transfer the appropriate number of cells are aliquoted into microwell plates (e.g., Nunc™ 96 Microwell™ plates). The individual wells are then grown to optimum confluency in complete media whereupon the media is replaced with serum-free media. At this point controls are untouched, but experimental wells are incubated with a modulator, e.g. EGF. After incubation with the modulator cells are fixed and stained with labeled antibodies to the activation elements being investigated. Once the cells are labeled, the plates can be scanned using an imager such as the Odyssey Imager (LiCor, Lincoln Nebr.) using techniques described in the Odyssey Operator's Manual v1.2., which is hereby incorporated in its entirety. Data obtained by scanning of the multiwell plate can be analyzed and activation profiles determined as described below.

In some embodiments, the detecting is by high pressure liquid chromatography (HPLC), for example, reverse phase HPLC, and in a further aspect, the detecting is by mass spectrometry.

These instruments can fit in a sterile laminar flow or fume hood, or are enclosed, self-contained systems, for cell culture growth and transformation in multi-well plates or tubes and for hazardous operations. The living cells may be grown under controlled growth conditions, with controls for temperature, humidity, and gas for time series of the live cell assays. Automated transformation of cells and automated colony pickers may facilitate rapid screening of desired cells.

Flow cytometry or capillary electrophoresis formats can be used for individual capture of magnetic and other beads, particles, cells, and organisms.

Flexible hardware and software allow instrument adaptability for multiple applications. The software program modules allow creation, modification, and running of methods. The system diagnostic modules allow instrument alignment, correct connections, and motor operations. Customized tools, labware, and liquid, particle, cell and organism transfer patterns allow different applications to be performed. Databases allow method and parameter storage. Robotic and computer interfaces allow communication between instruments.

In some embodiment, the methods of the invention include the use of liquid handling components. The liquid handling systems can include robotic systems comprising any number of components. In addition, any or all of the steps outlined herein may be automated; thus, for example, the systems may be completely or partially automated. See U.S. Ser. No. 61/048,657.

As will be appreciated by those in the art, there are a wide variety of components which can be used, including, but not limited to, one or more robotic arms; plate handlers for the positioning of microplates; automated lid or cap handlers to remove and replace lids for wells on non-cross contamination plates; tip assemblies for sample distribution with disposable tips; washable tip assemblies for sample distribution; 96 well loading blocks; cooled reagent racks; microtiter plate pipette positions (optionally cooled); stacking towers for plates and tips; and computer systems.

Fully robotic or micro fluidic systems include automated liquid-, particle-, cell- and organism-handling including high throughput pipetting to perform all steps of screening applications. This includes liquid, particle, cell, and organism manipulations such as aspiration, dispensing, mixing, diluting, washing, accurate volumetric transfers; retrieving, and discarding of pipet tips; and repetitive pipetting of identical volumes for multiple deliveries from a single sample aspiration. These manipulations are cross-contamination-free liquid, particle, cell, and organism transfers. This instrument performs automated replication of microplate samples to filters, membranes, and/or daughter plates, high-density transfers, full-plate serial dilutions, and high capacity operation.

In some embodiments, chemically derivatized particles, plates, cartridges, tubes, magnetic particles, or other solid phase matrix with specificity to the assay components are used. The binding surfaces of microplates, tubes or any solid phase matrices include non-polar surfaces, highly polar surfaces, modified dextran coating to promote covalent binding, antibody coating, affinity media to bind fusion proteins or peptides, surface-fixed proteins such as recombinant protein A or G, nucleotide resins or coatings, and other affinity matrix are useful in this invention.

In some embodiments, platforms for multi-well plates, multi-tubes, holders, cartridges, minitubes, deep-well plates, microfuge tubes, cryovials, square well plates, filters, chips, optic fibers, beads, and other solid-phase matrices or platform with various volumes are accommodated on an upgradable modular platform for additional capacity. This modular platform includes a variable speed orbital shaker, and multi-position work decks for source samples, sample and reagent dilution, assay plates, sample and reagent reservoirs, pipette tips, and an active wash station. In some embodiments, the methods of the invention include the use of a plate reader.

In some embodiments, thermocycler and thermoregulating systems are used for stabilizing the temperature of heat exchangers such as controlled blocks or platforms to provide accurate temperature control of incubating samples from 0° C. to 100° C.

In some embodiments, interchangeable pipet heads (single or multi-channel) with single or multiple magnetic probes, affinity probes, or pipetters robotically manipulate the liquid, particles, cells, and organisms. Multi-well or multi-tube magnetic separators or platforms manipulate liquid, particles, cells, and organisms in single or multiple sample formats.

In some embodiments, the instrumentation will include a detector, which can be a wide variety of different detectors, depending on the labels and assay. In some embodiments, useful detectors include a microscope(s) with multiple channels of fluorescence; plate readers to provide fluorescent, ultraviolet and visible spectrophotometric detection with single and dual wavelength endpoint and kinetics capability, fluorescence resonance energy transfer (FRET), luminescence, quenching, two-photon excitation, and intensity redistribution; CCD cameras to capture and transform data and images into quantifiable formats; and a computer workstation.

In some embodiments, the robotic apparatus includes a central processing unit which communicates with a memory and a set of input/output devices (e.g., keyboard, mouse, monitor, printer, etc.) through a bus. Again, as outlined below, this may be in addition to or in place of the CPU for the multiplexing devices of the invention. The general interaction between a central processing unit, a memory, input/output devices, and a bus is known in the art. Thus, a variety of different procedures, depending on the experiments to be run, are stored in the CPU memory.

These robotic fluid handling systems can utilize any number of different reagents, including buffers, reagents, samples, washes, assay components such as label probes, etc.

### Conditions

The methods of the invention are applicable to any condition in an individual involving, indicated by, and/or arising from, in whole or in part, altered biological state in cells. The term “biological state” includes mechanical, physical, and biochemical functions in a cell. In some embodiments, the biological state of a cell is determined by measuring characteristics of at least one cellular component of a cellular pathway in cells from different populations (e.g. different cell networks). Cellular pathways are well known in the art. In some embodiments the cellular pathway is a signaling pathway. Signaling pathways are also well known in the art (see, e.g., Hunter T., Cell 100(1): 113-27 (2000); Cell Signaling Technology, Inc., 2002 Catalogue, Pathway Diagrams pgs. 232-253; Weinberg, Chapter 6, The biology of Cancer, 2007; and Blume-Jensen and Hunter, Nature, vol 411, 17 May 2001, p 355-365). A condition involving or characterized by altered biological state may be readily identified, for example, by determining the state of one or more activatable elements in cells from different populations, as taught herein.

In certain embodiments of the invention, the condition is a neoplastic, immunologic or hematopoietic condition. In some embodiments, the neoplastic, immunologic or hematopoietic condition is selected from the group consisting of solid tumors such as head and neck cancer including brain, thyroid cancer, breast cancer, lung cancer, mesothelioma, germ cell tumors, ovarian cancer, liver cancer, gastric carcinoma, colon cancer, prostate cancer, pancreatic cancer, melanoma, bladder cancer, renal cancer, prostate cancer, testicular cancer, cervical cancer, endometrial cancer, myosarcoma, leiomyosarcoma and other soft tissue sarcomas, osteosarcoma, Ewing's sarcoma, retinoblastoma, rhabdomyosarcoma, Wilm's tumor, and neuroblastoma, sepsis, allergic diseases and disorders that include but are not limited to allergic rhinitis, allergic conjunctivitis, allergic asthma, atopic eczema, atopic dermatitis, and food allergy, immunodeficiencies including but not limited to severe combined immunodeficiency (SCID), hypereosiniphic syndrome, chronic granulomatous disease, leukocyte adhesion deficiency I and II, hyper IgE syndrome, Chediak Higashi, neutrophilias, neutropenias, aplasias, agammaglobulinemia, hyper-IgM syndromes, DiGeorge/Velocardial-facial syndromes and Interferon gamma-TH1 pathway defects, autoimmune and immune dysregulation disorders that include but are not limited to rheumatoid arthritis, diabetes, systemic lupus erythematosus, Graves' disease, Graves ophthalmopathy, Crohn's disease, multiple sclerosis, psoriasis, systemic sclerosis, goiter and struma lymphomatosa (Hashimoto's thyroiditis, lymphadenoid goiter), alopecia aerata, autoimmune myocarditis, lichen sclerosis, autoimmune uveitis, Addison's disease, atrophic gastritis, myasthenia gravis, idiopathic thrombocytopenic purpura, hemolytic anemia, primary biliary cirrhosis, Wegener's granulomatosis, polyarteritis nodosa, and inflammatory bowel disease, allograft rejection and tissue destructive from allergic reactions to infectious microorganisms or to environmental antigens, and hematopoietic conditions that include but are not limited to Non-Hodgkin Lymphoma, Hodgkin or other lymphomas, acute or chronic leukemias, polycythemias, thrombocythemias, multiple myeloma or plasma cell disorders, e.g., amyloidosis and Waldenstrom's macroglobulinemia, myelodysplastic disorders, myeloproliferative disorders, myelo fibroses, or atypical immune lymphoproliferations. In some embodiments, the neoplastic or hematopoietic condition is non-B lineage derived, such as Acute myeloid leukemia (AML), Chronic Myeloid Leukemia (CML), non-B cell Acute lymphocytic leukemia (ALL), non-B cell lymphomas, myelodysplastic disorders, myeloproliferative disorders, myelo fibroses, polycythemias, thrombocythemias, or non-B atypical immune lymphoproliferations, Chronic Lymphocytic Leukemia (CLL), B lymphocyte lineage leukemia, B lymphocyte lineage lymphoma, Multiple Myeloma, or plasma cell disorders, e.g., amyloidosis or Waldenstrom's macroglobulinemia.

In some embodiments, the neoplastic or hematopoietic condition is non-B lineage derived. Examples of non-B lineage derived neoplastic or hematopoietic condition include, but are not limited to, Acute myeloid leukemia (AML), Chronic Myeloid Leukemia (CML), non-B cell Acute lymphocytic leukemia (ALL), non-B cell lymphomas, myelodysplastic disorders, myeloproliferative disorders, myelo fibroses, polycythemias, thrombocythemias, and non-B atypical immune lymphoproliferations.

In some embodiments, the neoplastic or hematopoietic condition is a B-Cell or B cell lineage derived disorder. Examples of B-Cell or B cell lineage derived neoplastic or hematopoietic condition include but are not limited to Chronic Lymphocytic Leukemia (CLL), B lymphocyte lineage leukemia, B lymphocyte lineage lymphoma, Multiple Myeloma, and plasma cell disorders, including amyloidosis and Waldenstrom's macroglobulinemia.

Other conditions within the scope of the present invention include, but are not limited to, cancers such as gliomas, lung cancer, colon cancer and prostate cancer. Specific signaling pathway alterations have been described for many cancers, including loss of PTEN and resulting activation of Akt signaling in prostate cancer (Whang Y E. Proc Natl Acad Sci USA Apr. 28, 1998; 95(9):5246-50), increased IGF-1 expression in prostate cancer (Schaefer et al., Science Oct. 9, 1998, 282: 199a), EGFR overexpression and resulting ERK activation in glioma cancer (Thomas C Y. Int J Cancer Mar. 10, 2003; 104(1):19-27), expression of HER2 in breast cancers (Menard et al. Oncogene. Sep. 29 2003, 22(42):6570-8), and APC mutation and activated Wnt signaling in colon cancer (Bienz M. Curr Opin Genet Dev 1999 October, 9(5):595-603).

Diseases other than cancer involving altered biological state are also encompassed by the present invention. For example, it has been shown that diabetes involves underlying signaling changes, namely resistance to insulin and failure to activate downstream signaling through IRS (Burks D J, White M F. Diabetes 2001 February; 50 Suppl 1:S140-5). Similarly, cardiovascular disease has been shown to involve hypertrophy of the cardiac cells involving multiple pathways such as the PKC family (Malhotra A. Mol Cell Biochem 2001 September; 225 (1-):97-107). Inflammatory diseases, such as rheumatoid arthritis, are known to involve the chemokine receptors and disrupted downstream signaling (D'Ambrosio D. J Immunol Methods 2003 February; 273 (1-2):3-13). The invention is not limited to diseases presently known to involve altered cellular function, but includes diseases subsequently shown to involve physiological alterations or anomalies.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A computer-implemented method of classifying an individual according to a biological event, the method comprising:
receiving, at a computer comprising a memory and a processor, activation state data associated with an individual, where the activation state data comprises activation levels of a set of activatable elements in single cells from the individual; and
generating an association value based on the activation state data and a plurality of temporal models, wherein said plurality of temporal models are associated with a biological event, and wherein the association value specifies a likelihood that the individual is associated with a biological event.

2. The method of claim 1, wherein the biological event is selected from the group consisting of a drug response, a disease state and cellular differentiation.

3. The method of claim 1, wherein the activation state data is generated responsive to stimulating the single cells with a modulator.

4. The method of claim 1, wherein generating the association value based on the activation state data and the plurality of temporal models of a biological event comprises:
generating a first temporal model based on activation state data associated with one or more individuals who are known not to be associated with the biological event;
generating a second temporal model based on activation state data associated with one or more individuals who are known to be associated with the biological event; and
generating a classifier based on the first temporal model and the second temporal model.

5. The method of claim 4, wherein generating the classifier comprises:
generating a first set of descriptive metrics based on the first temporal model;
generating a second set of descriptive metrics based on the second temporal model; and
generating the classifier based on the first set of descriptive metrics and the second set of descriptive metrics.

6. The method of claim 4, further comprising:
generating a third temporal model based on the activation state data associated with the individual;
generating a set of descriptive metrics based on the third temporal model; and
applying the classifier to the set of descriptive metrics that are generated based on the temporal model for the individual.

7. The method of claim 1, further comprising:
administering a course of treatment to the individual based on the association value.

8. The method of claim 1, wherein the biological event corresponds to at least a first disease state and further comprising:
diagnosing the individual with the disease state based on the association value.

9. A method of classifying an individual according to a biological event, the method comprising:
generating activation state data associated with an individual where the activation state data comprises activation levels of a set of activatable elements in single cells from the individual;
generating an association value that specifies a likelihood that the individual is associated with a biological event based on the activation state data and a temporal model of a biological event; and
determining whether the individual is associated with the biological event based on said association value.

10. The method of claim 9, wherein generating an association value that specifies a likelihood that the individual is associated with a biological event based on the activation state data and a temporal model of a biological event comprises:
generating a plurality of temporal models based on data associated with a plurality of a samples of single cells collected from a plurality of individuals known to be associated with the biological event;
combining the plurality of temporal models to generate a template temporal model, wherein the template temporal model represents the biological event; and
generating an association value based on the activation state data associated with an individual and the template temporal model, wherein the association value specifies the correlation between the activation state data associated with the individual and the template temporal model.

11. The method of claim 10, further comprising:
generating a confidence value, wherein the confidence value specifies the probability of observing the correlation between the activation state data associated with the individual and the template temporal model.

12. The method of claim 10, further comprising:
displaying the activation state data associated with the individual in association with a graphic visualization of the template temporal model, wherein the activation state data associated with the individual is overlaid on the graphic visualization of the template temporal model.

13. The method of claim 1, wherein the activation state data in said single cells have been determined under culture conditions comprising a modulator.

14. The method of claim 13, wherein the activation state data in said single cells have been determined under culture conditions comprising a plurality of modulators.

15. The method of claim 13, wherein the modulator is selected from the group of consisting of an activator, an inhibitor and a therapeutic agent.

16. The method of claim 13, wherein the modulator is a chemotherapeutic agent, the biological event is response to the chemotherapeutic agent and the set of activatable elements comprise activatable elements associated with the JAK/STAT pathway.

17. The method of claim 9, wherein the biological event is acute myeloid leukemia and the set of activatable elements is selected from the group consisting of CD34, CD33, pSTAT5, pSTAT3 and CD11b.

18. The method of claim 9, further comprising administering a course of treatment to the individual based on the association value.

19. The method of claim 9, wherein the biological event corresponds to at least a first disease state and further comprising diagnosing the individual with the disease state based on the association value.
